(19) United States
(12) Patent Application Publication
(10) Pub. No.: US 2018/0121766 A1
(43) Pub. Date: May 3, 2018

(54) ENHANCED HUMAN/MACHINE WORKFORCE MANAGEMENT USING REINFORCEMENT LEARNING

(71) Applicant: NEWVOICEMEDIA, LTD., Basingstoke (GB)

(72) Inventors: Alan McCord, Frisco, TX (US); Ashley Unitt, Basingstoke (GB)

(21) Appl. No.: 15/876,767

(22) Filed: Jan. 22, 2018

Related U.S. Application Data
(63) Continuation-in-part of application No. 15/442,667, filed on Feb. 25, 2017.
Application No. 15/442,667 is a continuation-in-part of application No. 15/268,611, filed on Sep. 18, 2016.
(60) Provisional application No. 62/441,538, filed on Jan. 2, 2017.

(51) Int. Cl. G06K 9/62; G06N 3/08; G06N 7/00; G06Q 10/06

(52) U.S. Cl. CPC G06K 9/6297; G06Q 10/06311; G06N 7/005; G06N 3/08

(57) ABSTRACT

A system and method for enhanced human/machine workforce management using reinforcement learning, comprising a reinforcement learning server that produces a partially-observable Markov chain model, and an optimization server that uses the partially-observable Markov chain model to select work items and assign them to contact center resources.

### CROSS-REFERENCE TO RELATED APPLICATIONS

This application is a continuation-in-part of U.S. patent application Ser. No. 15/442,667 titled “SYSTEM AND METHOD FOR OPTIMIZING COMMUNICATION OPERATIONS USING REINFORCEMENT LEARNING”, filed on Feb. 25, 2017, which claims priority to U.S. provisional patent application Ser. No. 62/441,538, titled “SYSTEM AND METHOD FOR OPTIMIZING COMMUNICATION OPERATIONS USING REINFORCEMENT LEARNING”, which was filed on Jan. 2, 2017, and is also a continuation-in-part of U.S. patent application Ser. No. 15/268,611, titled “SYSTEM AND METHOD FOR OPTIMIZING COMMUNICATIONS USING REINFORCEMENT LEARNING”, filed on Sep. 18, 2016, the entire specifications of each of which are incorporated herein by reference.

### BACKGROUND

### Field of the Art

The disclosure relates to the field of workforce management, and particularly to the field of workforce optimization through the use of analytics and learning systems to optimize engagement in contact centers.

### Discussion of the State of the Art

In workforce management (WFM) within contact centers, there are two main types of workload to be handled, “imperative” and “contingent” demand. Imperative demand refers to work that has to be handled immediately, such as inbound calls in a contact center. Contingent demand refers to less time-sensitive work items like emails, account operations, case handling, chats, or other tasks that do not generally require immediate handling and can be arranged around imperative tasks to efficiently utilize resource availability.

What is needed is a way to automatically manage the assignment and distribution of work items to minimize context-switching and improve resource utilization in a contact center.

### SUMMARY

Accordingly, the inventor has conceived and reduced to practice, a system and method for enhanced workforce management using reinforcement learning, that minimizes context-switching and automatically selects work items for routing to resources to optimize resource availability and work item allocation.

The aspects described herein present a system and method for enhanced workforce management using reinforcement learning, comprising a reinforcement learning server that produces a fully- or partially-observable Markov chain model, and an optimization server that uses the partially-observable Markov chain model to select work items and assign them to contact center resources to minimize context-switching and improve outbound contact center performance by improving the selection and distribution of work items for handling.

According to one aspect, a system for enhanced workforce management using reinforcement learning comprising: a reinforcement learning server comprising at least a plurality of programming instructions stored in a memory and operating on a processor of a computing device and configured to: receive a plurality of historical data from a contact center; form a partially-observable Markov chain model based at least in part on at least a portion of the historical data; provide the partially-observable Markov chain model to an optimization server; an optimization server comprising at least a plurality of programming instructions stored in a memory and operating on a processor of a computing device and configured to: receive a partially-observable Markov chain model from a reinforcement learning server; select a plurality of work tasks based at least in part on the partially-observable Markov chain model; select a plurality of contact center resources; assign each of the selected work tasks to at least one of the plurality of contact center resources; record and analyze a plurality of observations based on each selected resource's performance of each work task assigned to it; provide the observations to the reinforcement learning server; a retrain and design server comprising at least a plurality of programming instructions stored in a memory and operating on a processor of a computing device and configured to: observe and analyze a plurality of historical data from a contact center; provide at least a portion of the historical data to a reinforcement learning server; define a plurality of reward values to direct the operation of the reinforcement learning server; and design and train a Markov decision process model based at least in part on the partially-observable Markov chain model, using at least a portion of the defined reward values, is disclosed.

According to another aspect, a method for enhanced workforce management using reinforcement learning, comprising the steps of: receiving, at a retrain and design server comprising at least a plurality of programming instructions stored in a memory and operating on a processor of a computing device, a plurality of historical data from a contact center; defining a plurality of reward values to direct the operation of a reinforcement learning server; providing at least a portion of the historical data to a reinforcement learning server for use in a partially-observable Markov chain model; forming, using a reinforcement learning server, a partially-observable Markov chain model based at least in part on the historical data; selecting, using an optimization server, a plurality of work tasks based at least in part on the partially-observable Markov chain model; selecting a plurality of contact center resources; assigning each of the selected work tasks to at least one of the plurality of contact center resources; training a Markov decision process model based at least in part on the partially-observable Markov chain model, using at least a portion of the defined reward values, is disclosed.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 (PRIOR ART) is a block diagram illustrating an exemplary system architecture for a contact center.

FIG. 2 is a block diagram illustrating an exemplary system architecture for a contact center utilizing a reinforcement learning module comprising a reinforcement learning server and an optimization server, according to one aspect.

FIG. 3 is a block diagram illustrating an expanded view of an exemplary system architecture for a reinforcement learning module that uses a reinforcement learning server comprised of a train and design server, a history database, training sets, a routing and action server, a learning database, and a state and statistics server; and an optimization server comprised of a model, a model manager, an event handler, an action handler, and interfaces, according to one aspect.

FIG. 4 is an exemplary state transition diagram illustrating a plurality of events that may occur in one or more possible stages during reinforcement learning, according to one aspect.

FIG. 5 is a flow diagram illustrating an exemplary method for creating a partially observable Markov decision process for use by the reinforcement learning module, according to one aspect.

FIG. 6 is a flow diagram illustrating an exemplary method for reinforcement learning, according to one aspect.

FIG. 7 is a flow diagram illustrating an exemplary method for optimizing states of communications and operations in a contact center by using a reinforcement learning module, according to one aspect.

FIG. 8 is a flow diagram illustrating an exemplary method for optimal interaction planning for outbound sales leads, depicted as a sales funnel with actions with a fully observable Markov decision process, according to one aspect.

FIG. 9 is a flow diagram illustrating an exemplary method for optimal interaction planning for outbound sales leads, depicted as a sales funnel with actions with a partially observable Markov decision process, according to one aspect.

FIG. 10 is a flow diagram illustrating an exemplary method for creating a fully observable Markov decision process for use by the reinforcement learning system, according to one aspect.

FIG. 11 is a an exemplary state transition diagram using a non-stationary hyper-policy for optimal interaction planning for routing communications and staffing agent resources, using a fully observable Markov decision process, according to one aspect.

FIG. 12 is a block diagram illustrating an exemplary hardware architecture of a computing device.

FIG. 13 is a block diagram illustrating an exemplary logical architecture for a client device.

FIG. 14 is a block diagram showing an exemplary architectural arrangement of clients, servers, and external services.

FIG. 15 is another block diagram illustrating an exemplary hardware architecture of a computing device.

FIG. 16 is an exemplary state transition diagram illustrating a plurality of events that may occur in one or more possible stages during management of state explosion within reinforcement learning applications associated with optimized workforce management according to one aspect.

FIG. 17 is a flow diagram depicting an exemplary method for reducing and managing state explosion that may occur with high dimensional data, according to one aspect.

FIG. 18 is another flow diagram depicting an exemplary optimized proximity method for reducing and managing state explosion that may occur with high dimensional data, according to one aspect.

FIG. 19 is a set of diagrams presented to illustrate context-switching costs and the selection of an agent routing solution, according to one aspect.

FIG. 20 is an illustration of a workforce management approach that manages both imperative and contingent demand types, according to one aspect.

### DETAILED DESCRIPTION

The inventor has conceived, and reduced to practice, a system and method for enhanced workforce management using reinforcement learning, that minimizes context-switching and automatically selects work items for routing to resources to optimize resource availability and work item allocation.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“Workforce”, as used according to the various aspects described herein, may refer to any plurality of humans and/or artificial intelligence (AI) “bots”. Various combinations of bots and humans may operate and interact as a group entity, and workforce management principles and techniques may be applied to such human/AI mixtures as well as “pure” all-human or all-AI groups.

### Conceptual Architecture

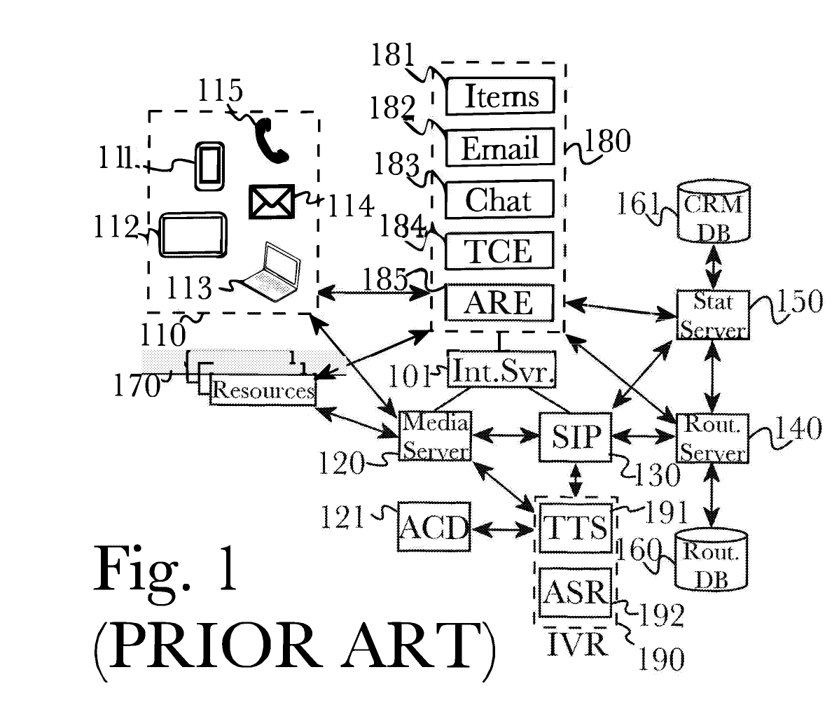

FIG. 1 (PRIOR ART) is a block diagram of an exemplary system architecture for a contact center. According to the aspect, a plurality of interaction types 110 may be received from a variety of services or devices, such as (for example, including but not limited to) a smartphone 111, tablet computing device 112, personal computer 113, email service 114, telephone network 115, or smarthome device 116 such as (for example, including but not limited to) a smart speaker such as AMAZON ECHO™ or APPLE HOMEPOD™. Interactions 110 may be delivered to, or initiated outward from, media server 120 or an appropriate text-based interaction handler 180, according to the specific nature of the interaction, by an interaction server 101 that operates as a central interaction handler for routing interactions appropriately based on their type or context. Text-based handlers 180 may comprise handlers for work items 181 such as internal actionable items that may not necessarily involve customer interaction directly (for example, processing a credit application, which is certainly a part of a customer interaction but is handled fully “behind the scenes”), email server 182 for handling email messages, chat server 183 for handling IP-based chat interactions, text classification engine (TCE) 184 for classifying and routing text-based interactions appropriately, and autoresponse engine (ARE) 185 for automatically responding to text interactions when possible (for example, for producing automated responses to simple account-related queries).

In some arrangements where a single medium (such as telephone calls) is used for interactions which require routing, media server 120 may be more specifically a private branch exchange (PBX), or an automated call distributor (ACD) 121 may be utilized, or similar media-specific switching system. Interactions may be received via an interactive voice response (IVR) 190 that may comprise text-to-speech 191 and automated speech recognition 192 elements to provide voice prompts and handle spoken input from callers. Generally, when interactions arrive at media server 120, a route request, or a variation of a route request (for example, a SIP invite message), is sent to session initiation protocol SIP server 130, or to an equivalent system such as a computer telephony integration (CTI) server. A route request may comprise a data message sent from a media-handling device such as media server 120 to a signaling system such as SIP server 130, the message comprising a request for one or more target destinations to which to send (or route, or deliver) the specific interaction with regard to which the route request was sent. SIP server 130 or its equivalent may, in some arrangements, carry out any required routing logic itself, or it may forward the route request message to routing server 140. In one aspect, routing server 140 uses historical or real time information, or both, from statistics server 150, as well as configuration information (generally available from a distributed configuration system, not shown for convenience) and information from routing database 160. Routing database 160 may comprise multiple distinct databases, either stored in one database management system or in separate database management systems, and additional databases may be utilized for specific purposes such as (for example, including but not limited to) a customer relationship management (CRM) database 161. Examples of data that may normally be found in a database 160, 161 may include (but are not limited to): customer relationship management (CRM) data; data pertaining to one or more social networks (including, but not limited to network graphs capturing social relationships within relevant social networks, or media updates made by members of relevant social networks); skills data pertaining to a plurality of resources 170 (which may be human agents, automated software agents, interactive voice response scripts, and so forth); data extracted from third party data sources including cloud-based data sources such as CRM and other data from Salesforce.com, credit data from Experian, consumer data from data.com; or any other data that may be useful in making routing decisions. It will be appreciated by one having ordinary skill in the art that there are many means of data integration known in the art, any of which may be used to obtain data from premise-based, single machine-based, cloud-based, public or private data sources as needed, without departing from the scope of the invention. Using information obtained from one or more of statistics server 150, routing database 160, CRM database 161, and any associated configuration systems, routing server 140 selects a routing target from among a plurality of available resources 170, and routing server 140 then instructs SIP server 130 to route the interaction in question to the selected resource 170, and SIP server 130 in turn directs media server 120 to establish an appropriate connection between interaction 110 and target resource 170. It should be noted that interactions 110 are generally, but not necessarily, associated with human customers or users. Nevertheless, it should be understood that routing of other work or interaction types is possible, according to the present invention. For example, in some arrangements work items, such as loan applications that require processing, are extracted from a work item backlog or other source and routed by a routing server 140 to an appropriate human or automated resource to be handled.

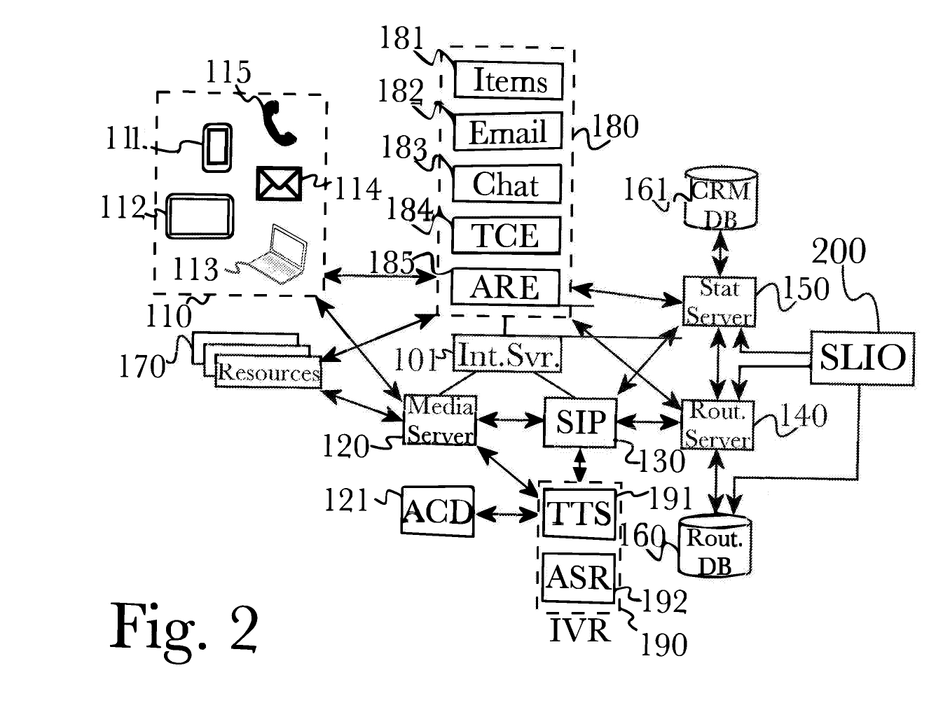

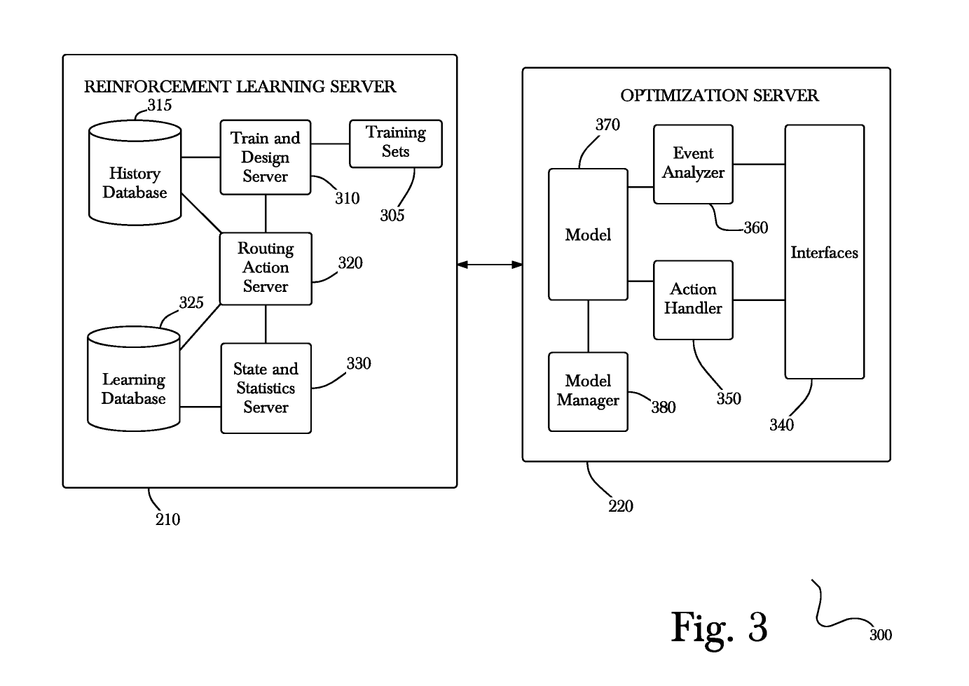

FIG. 2 is a block diagram illustrating an exemplary system architecture for a contact center utilizing a self-learning interaction optimizer (SLIO) 200 comprising a reinforcement learning server 210 and an optimization server 220 (both shown below in FIG. 3), according to one aspect. The optimization server 220, may communicate with the reinforcement learning server 210, in order to manage and maintain models for operations and control of routing functions and other similar processes associated with connecting resources 170 to customers 110 in an optimized and efficient manner, such as increasing efficiencies by decreasing wait times or assigning tasks to available resources. The reinforcement learning server 210 may also communicate with a plurality of contact center components in order to access historical and real-time data for incorporation into the design and retraining of models which are then applied by the optimization server 220 to assign tasks to a plurality of contact center components to achieve a desired goal or outcome. The reinforcement learning server 210 and the optimization server 220 work together and in circular and iterative approaches to arrive at decisions, implement decisions as actions, and learn from results of actions which may be incorporated into future models. Collectively, SLIO 200 along with reinforcement learning server 210 and the optimization server 220 comprises a plurality of contact center components adapted to handle interactions of one or more specific channel, be it text channels 180, or multimedia channels 120, resources 170, or customers 110.

FIG. 3 is a block diagram illustrating an expanded view of an exemplary system architecture for a SLIO 200, that uses a reinforcement learning server 210, comprising a retrain and design server 310, a history database 315, training sets 305, a routing and action server 320, a learning database 325, and a state and statistics server 330; and an optimization server 220, comprising a Markov model 370, a model manager 380, an event handler 360, an action handler 350, and interfaces 340, according to a one aspect. The state and statistics server 330, is responsible for representing and tracking current, real-time states, with a subsystem dedicated to pure Markov model representations of state that are efficiently stored in memory as sparse arrays and is capable of performing large scale and high speed matrix operations, optionally using specialized processors such as computation coprocessors such as Intel XEON PHI™ or graphics processing units (GPUs) such as NVidia TESLA™ instead of CPUs 41. Markov states include all information to be used, available within reinforcement learning system 200. Any aggregate counts or historical information is stored as a specific state for this purpose, in the learning database 325, and in the history database 315, respectively. In this way, a Markov assumption is not restrictive, and any process computed with the reinforcement learning server 210, and the optimization server 220, may be represented as a Markov process, within SLIO 200 with the reinforcing learning module 210.

Reinforcement learning follows a productive process, training a model 370, and when the model 370 is ready, run it through subsets of training sets 305 to simulate real-time events. States are learned by reviewing history from the history database 315. Some examples of states include dialing, ringing, on a call, standby, ready, on a break, etc. Once the model 370 has been tested, it is set into motion in live action, and it controls a routing and action server 320 which then works to record more history to store in the history database 315, creates training sets 305, and reapply the model 370 based on more data, learning from more data. Once live, an optimization server 220 is engaged to control actions. Components of SLIO 200 work in “black-box” scenarios, as stand-alone units that only interface with established components, with no realization that other components exist in the system. Within the optimization server 220 an action handler 350 may act as a pacing manager, in communication with contact center systems via interfaces 340. The action handler 350 may also concern itself with dialing and giving orders to hardware to dial, receive status reports, and translate dialing results, such as connection, transfer, hang-up, etc. The action handler 350 dictates actions to the SLIO 200. The model 370 is comprised of a set of algorithms, but the action handler 350 uses the model 370 to decide and determine optimal movements and actions, which are then put into action, and the optimization server 220 learns from actions taken in real-time and incorporates observations and results to determine a further optimal actions. The event analyzer 360 receives events from the state and statistics server 330, or the statistics server 150, or any other contact center components, and then receives events as states, interprets events (states) in terms of the model 370, then decides what optimal actions to take and communicates with the action handler 350 which then decides how to implement a chosen action, and sends it via interface 340 out to any of the server components, such as statistics server 150, routing server 140, and so forth. The event analyzer 360 receives events, interprets events in accordance with the model 370, and based on results, actions are determined to be executed. An action is a directive to do something. Actions are handled by the action handler 350. An event, or state, is a recording that something has been done. Actions lead to states, and states trigger actions. The model manager 380 maintains the model 370 while inputs are being received. Once put into action, the reinforcement learning module 210 is learning as time advances. Any event, or state, being introduced passes through the reinforcement learning server 210 and any event, or state, being acted upon by the optimization server 320 passes back through the reinforcement learning server 210. Following this logic, the reinforcement learning module 1200 sees what is happening in a current state as well as records respective results of actions taken.

The optimization server 220 carries out instructions from the model 370 by analyzing events with the event analyzer 360, and sending out optimal actions to be executed by the action handler 350 based on those events. The reinforcement learning server 210, during runtime, may be receiving a plurality of events, and action directives, and interpreting them, and adjusting new actions as time advances. The model manager 380 receives increments from the model 370, and from the reinforcement learning server 210, and dynamically updates the model 370 that is being used. Model manager 380 maintains a version of what is the current model 370, as well as have the option to change the model 370 each time an incremental dataset is received, which may even mean changing the model every few minutes, or even seconds, OR after a prescribed quantity of changes are received.

### Detailed Description of Exemplary Aspects

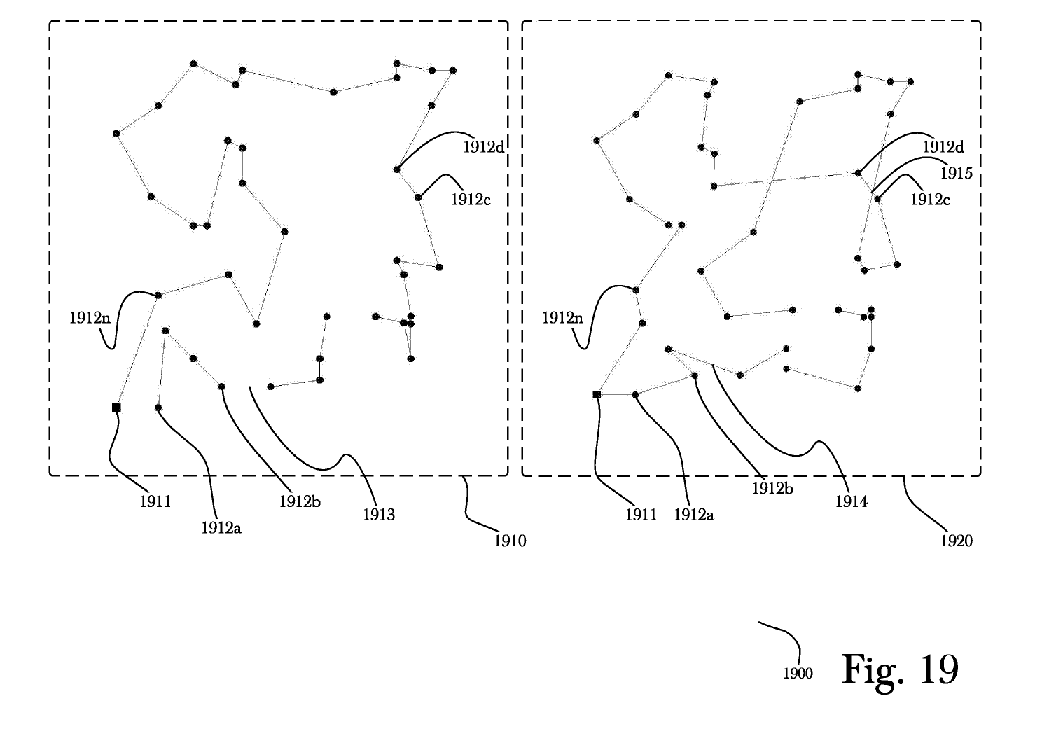

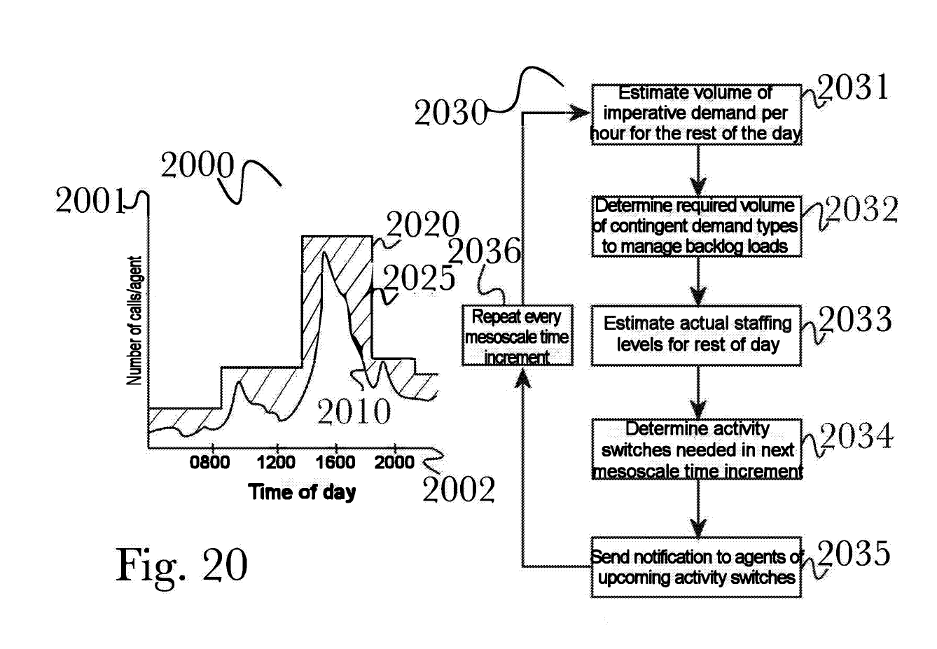

FIG. 20 is a diagram of a preferred embodiment of the invention, in which interaction server 101 manages both imperative and contingent demand types. For example, an agent may be working on a variety of contingent-demand work items when an inbound call is routed to them for immediate handling, and they can direct their attention to the imperative demand while the work items are set aside to continue later. In some arrangements an agent may even continue working on contingent items such as asynchronous chat interactions with other customers while on a call. Dynamically managing the assignment of work items using the self-learning functionalities provided by SLIO 200 enables more efficient utilization of agent time and other resources, both by managing the distribution of contingent work items so that resources are neither over or underutilized, and also by selecting work items to minimize context-switching costs and improve productivity (as described below, referring to FIG. 19).

A general premise of WFM is to attempt to regulate resource availability levels (such as agent staffing) to match a workload curve. Applying this to outbound interaction workload requires resource availability to be handled in a proactive manner, rather than the reactive optimization allowed when handling inbound interactions. A technique known as predictive routing tries to predict factors such as (for example, including but not limited to) interaction load or resource availability such as agent staffing levels. Predictions may also be made concerning outbound dial success rate, and these may be used to direct an interaction server 101 to dial multiple calls based on anticipated success rates, for example to keep agents as busy as possible by always having interactions ready for handling as soon as an agent is available. This approach is not popular with consumers, as it often results in a consumer receiving a call and then being asked to hold for an available agent, and predicted dialing success rates do not always align with actual rates, resulting in the risk of large numbers of interactions on hold while resource availability catches up to the workload. An alternate technique of progressive dialing waits for resource availability before attempting an outbound interaction, making it more popular with consumers (as they do not have to wait on hold for an agent), but is less efficient overall.

Relaxed predictive dialing is a combined approach that blends the advantages of predictive and progressive methods, preventing overdialing while also increasing customer satisfaction and efficiently managing resource availability with respect to interaction loads. Preview dialing may be employed to present an agent with a preview of customer info prior to dialing, so the agent may begin the interaction with some familiarity with the customer account, improving satisfaction as customers are given the impression of more familiar, personalized service where the agent with whom they are speaking knows their information and is familiar with their needs.

According to the aspect, graph 2000 comprising a line chart 2010 and a step graph 2020 represents number of calls per agent along the y-axis 2001 and x-axis 2002 denotes the time of day. This graph represents calculated forecast values for imperative demand and represents actual staffing requirements for the forecasted imperative demand. In this example, graph 2000 illustrates how resource planners can optimize staffing by creating a resource schedule (denoted by step graph 2020) that only loosely conforms to the imperative demand requirements (denoted by line chart 2010). Specifically, planners start with imperative demand (curve 2010), and then create a resource buffer (region 2025) that represents additional staffing that can be used either to handle imperative demand that may exceed forecasted levels, or to handle contingent demand. In particular, interaction server 101 may typically take a target overall contingent demand completion level (for example, based on managing one or more backlog levels for contingent demand types, or for providing a specified minimum or maximum amount of time for training purposes, and so forth) for a time period (for instance, a day), and then distribute that workload across shorter time increments (for each of which a forecasted imperative demand and resulting staffing required to handle imperative demand is known), thus spreading contingent demand work across the longer time period in such as a way as to allow a relative simple, stepwise staffing plan to be implemented. Accordingly, step graph 2020 represents an amount of resources required for the number of calls per agents (i.e. the value on the corresponding point on y-axis 2001) forecasted for the specific time of day (i.e. the value on the corresponding point on x-axis 2002). This creates a scenario that is an considerable improvement over the current state of the art, in that a conventional WFM system that manages both imperative and contingent demand types includes an increased availability of resources, as symbolized by resource buffer 2025, and a minimized number of “steps” in step graph 2020 for added flexibility in having additional resources to handle contingent demand as well as additional resources to address unforeseen short-term increases in imperative demand, unexpected staffing issues and other incidents which may have previously caused an over or understaffing situation in current WFM systems known in the art. Resource buffer 2025 symbolizes an increased amount of resources available relative to the forecasted imperative demand denoted by line chart 2010 for a given time of day (denoted by x-axis 2002). That is, the resource schedule (denoted by step graph 2020), in this case, provides a much greater availability of resources than the current state of the art for imperative demand (denoted by line chart 1210) that can, via real-time processes (described later in this document), be shifted to work on contingent demand (or additional imperative demand) as the state of imperative demand versus contingent demand requires, at any given time during the operation of the system.

Once a forecast of imperative demand is calculated using historical work data, staffing levels calculated, and staff shifts and roster created in a similar fashion outlined earlier in this document, a forecast resembling, for example, graph 2010 results. Process diagram 2030 outlines a typical process involved in a WFM system that manages both imperative and contingent demand types in a mesoscale time frame. That is, a schedule based on time increments that are intermediate between long-range time scales (for example, weekly, monthly, or quarterly schedules) and short-range time scales (typically minute-by-minute), and on a coarse level of granularity of detail (for example, by creating a schedule that provides a rough estimate of overall staffing adequate to handle forecasted imperative demand and contingent demand). In step 2031 an estimate of volume of imperative demand per hour for the rest of the day is calculated, for example, using work data from the current day, data from similar traffic patterns in the past, a combination of both, or some other datasets available in the system or externally. The system also determines the required volume of contingent demand types to manage backlog loads in step 2032 by taking into account the total number of backlog items, the number of desired backlog items, the target number of backlog items to process for a given time period (for example in the next hour, for the day, or some other time period) via a pre-configuration (not shown) or a real-time directive (not shown) or some other time period indicator. For example, if there is a backlog at the start of the day that equals 1000 units of work and the system expects 150 additional units of work to arrive during the day, then the total number of work items in the contingent demand for the day would be 1150 units of work. If the desire is, for example, to reduce the current backlog of 1000 units of work by 150 units of work then the contingent demand is 300 units of work that will need to be completed during the day (this, of course, is taking into account the additional 150 units of work that are predicted to arrive during the day). In this example, the time period for completing contingent demand work items is by the end of the day, so it does not matter at what time during the day the work items are completed (hence the demand is “contingent”).

It is important to have an adequate amount of contingent demand work items in reserve (i.e. a backlog of contingent demand). For example, emails awaiting a reply, social media interactions that require the intervention of a resource, and the like, in order to have work items to assign to resources for when there is a surplus in resources (for example, there are more resources available than there are imperative work items to work on). By having a backlog of contingent demand, a WFM system that handles imperative and contingent demand can function properly in that the operation will allow for additional resources to be available. This is a significant departure from WFM systems known in the art since in current systems, an approach such as this would result in an over-staffed situation. However, in this approach what is perceived as over-staffing is actually a strategy to staff for contingent demand work items. If interaction server 101 is allowed to exhaust available contingent demand backlog, then there will indeed be an inefficient (overstaffed) situation. In a situation where contingent demand backlog is incrementally increasing, resource buffer 2025 can be configured to create a larger disparity with respect to imperative demand 2010. In other words, the area (i.e. resource buffer 2025) between imperative demand line graph 2010 and resources step graph 2020 can be increased which has the effect of essentially adding additional resources that can handle imperative demand when needed and handle contingent demand to attenuate contingent demand backlog. Once the imperative demand and contingent demand is calculated, an estimate of the actual staffing levels for the rest of the day is calculated in step 2033. In step 2034 activity switches needed in a next mesoscale time increment are determined by interaction server 101 to ensure that resources are focused on one activity at a time, switching only periodically as required, rather than on an interaction-by-interaction basis as has been done previously in the art. For example, a configuration setting might be established (based for example on data analysis pertaining to fatigue and context-switching effects on workers), that resources may be required to work on particular activities for at least, for example, thirty minutes, to minimize any inefficiency created by a context switch. Interaction server 101 may also determine parameters regarding which specific activities (for example, imperative demand work items or contingent demand work items) particular resources will work on based on fairness rules, legal requirements, licensing requirements, union agreements, training requirements, some other constraint or configuration that may require an activity to be limited or extended for particular resources (or classes of resources), or given the current state of imperative demand versus contingent in a communication center environment (for example, if there is a decrease in imperative demand volume, activity manager may decide to switch a number of resources that have been handling imperative demand work items to handle contingent demand work items such as web barge-in, email interactions, social media interactions and the like). In this case, interaction server 101 sends notification 2035 to agents of upcoming context switches, and when the time increment expires, the process begins again 2036.

The benefits of a system where imperative and contingent demand are treated as interchangeable units of work where the same group of resources handle both types of demand as needed and where there is a continuous arrangement of additional resources, creates an improvement over current WFM systems known in the art from many perspectives. By having a perceived overstaffed staffing plan, there are always enough resources to handle any level of short-term increases in imperative demand, for example, if there was a 20% increase in imperative demand at a particular time during the day, there will be enough resources given a current staffing level to handle the unexpected increase in traffic. Furthermore, this staffing arrangement reduces the need for time management required in the current state of the art significantly. Since the staffing arrangement uses a minimized quantity of “steps” in which levels need to be changed, resources are free to retain flexibility in their shifts (for example, they may arrive early or late for the start of their shift, they may elect to leave early or late at the end of their shift, they may take breaks when they desire, and/or they may combine breaks and meals with their friends). This not only increases employee satisfaction, but may create cohesiveness between team members and a more pleasant working environment (which tends to improve resource retention, which in turn improves resource productive and service quality, and reduces training costs). Furthermore, when a situation arises where there is one or more unplanned staff absences, there will be enough resources to handle imperative demand. This type of environment has been shown to indirectly increase customer satisfaction due to happier employees and promotes employee retention, which, in turn, increases revenue and decreases expenses.

From another perspective, by combining imperative and contingent demand, when situations arise where there is a decrease in imperative demand, by maintaining a careful balance of contingent demand work items, interaction server 101 may assign contingent demand work items to the idle resources making it so that the system will not typically be in an overstaffed situation since there will be enough contingent work items to occupy the resources, thus having a situation where resources do not have to be forced to leave their shift early (as is common in the current state of the art) or have resources in a state of boredom because there is not enough work items. This, again, increases employee satisfaction and retention that reduces expenses whilst contingent demand items are handled more efficiently which increases customer satisfaction and impacts revenue in a positive way.

A workforce may comprise any combination of human and virtual bot workers, for example a number of human contact center agents that operate alongside AI-based chatbots, virtual assistants, or automated backend processing bots that may handle a variety of “offline” tasks without directly interacting with customers or agents (for example, processing account changes or other work items). Reinforcement learning may be used to determine the most efficient distribution of imperative and contingent work items among human and virtual bot workers, using both positive- and negative-reinforcement learning to “zero in” on optimized work allocation and assigning tasks to humans and virtual bots according to which is more suited to the work needed.

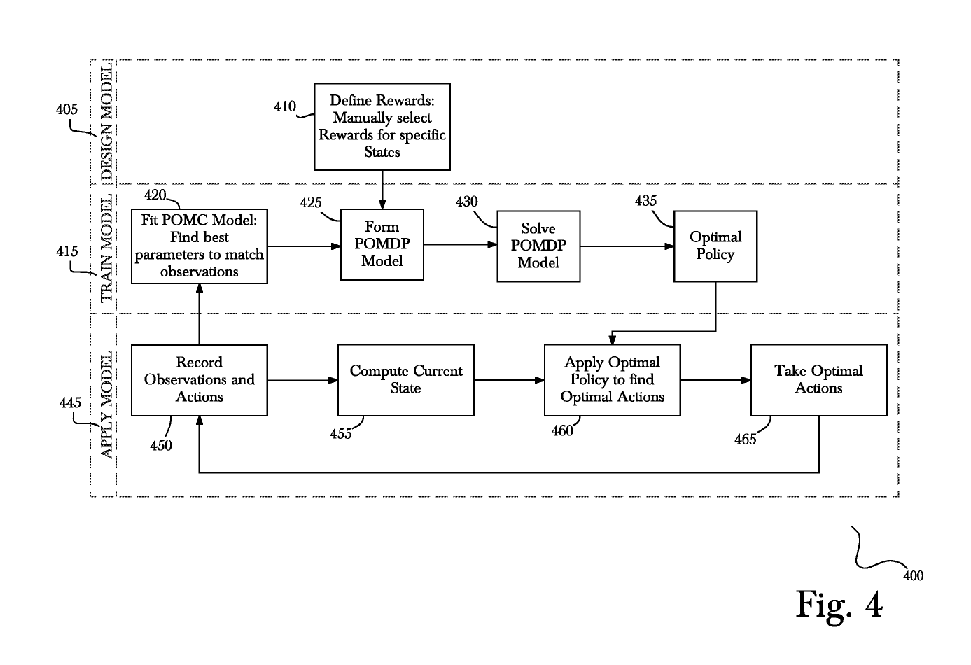

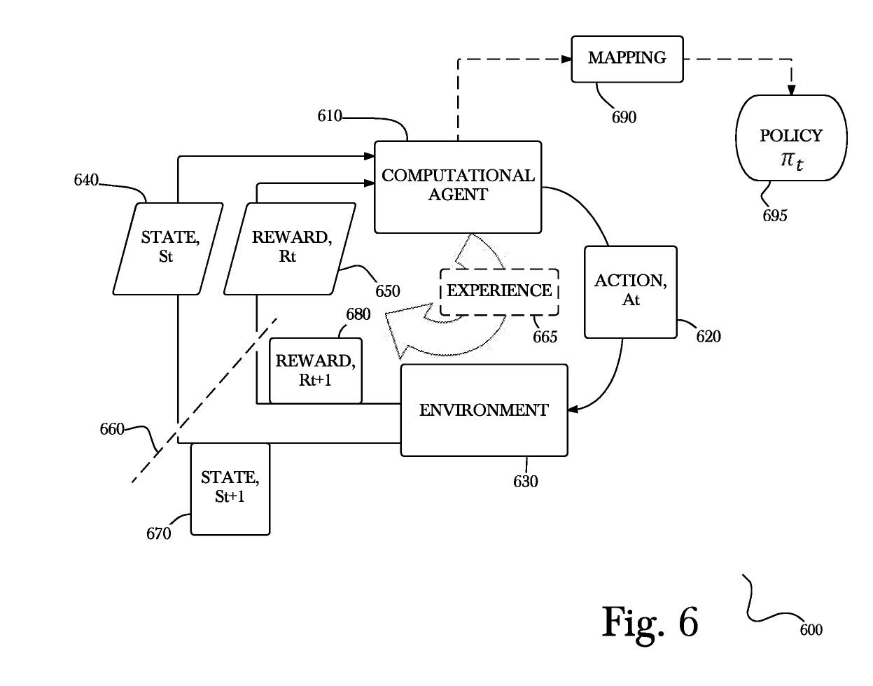

FIG. 4 is an exemplary state transition diagram 400 illustrating a plurality of events that may occur in one or more possible stages during reinforcement learning, according to one aspect. Reinforcement learning may be performed as an iterative process, in which a model is first designed 405, then trained 415, and lastly applied 445. After a model is applied in stage 445, results from this application may be fed back into the training state 415, such that another model may be designed, trained using the new results, and applied as an improved model incorporating the knowledge gained from the previous application. This approach is further detailed below, with reference to FIG. 6.

Within a design stage 405, rewards may be manually defined and selected to be applied to specific states 410, to achieve a desired outcome from the overall SLIO 200. In the training stage 415, first a partially observable Markov chain may be selected and fitted to find desirable parameters to match observations 420, then a Baum-Welch algorithm may be used to infer parameters of the partially observable Markov chain based on observations. Rewards may be added to form a partially observable Markov decision process model 425, which may then be solved 430 to provide an optimal action policy 435, to use and apply 445 for each state within SLIO 200. With the optimal action policy 435 identified in the training stage by the reinforcement learning server 210, the optimization server 220 works to apply the optimal policy to find optimal actions 460 within SLIO 200. The optimization server 220 then takes optimal actions 465 by assigning them to the respective contact center components 150 via the action handler 350 and the associated interfaces 340. As optimal actions are taken, an event analyzer 360 records resulting observations and actions 450 and both sends the records back to the reinforcement learning server 210 to use to fit to a new partially observable Markov chain model 420 as well as keep within the event analyzer 360 to compute a current state 455 associated with the optimal action. The model manager 380 then prompts the reinforcement learning server 210 to process the recorded observations and actions 450 to find the best parameters to match the observations 420 while pushing the event analyzer 360 to compute the current state 455 to again, apply optimal policy to find optimal actions 460, and so forth. Hence, two cyclic processes emerge once a first optimal policy is applied: 460, 465, 450, 455, 460 as one cycle in the apply model 445 stage, and 460, 465, 450, 420, 425, 430, 435, 460 as the train model 415 cycle. The design model stage 405 and train model stage 415 is a probabilistic graphical method based on Markov's assumption that future behavior is completely determined by a current state.

Reward values may also be used to provide negative reinforcement learning, for example by defining negative reward values to train away from certain states or outcomes. This may be used, for example, to enforce AI safety and steer machine learning away from actions that may violate policies or cause adverse effects, and may further be used to trigger log or reporting events when negative states or actions occur, such as when reinforcement learning is training toward something that should instead be avoided, or if a malicious actor is altering operation (for example, if a reinforcement learning server 210 has been hacked and is being manipulated to cause undesirable outcomes).

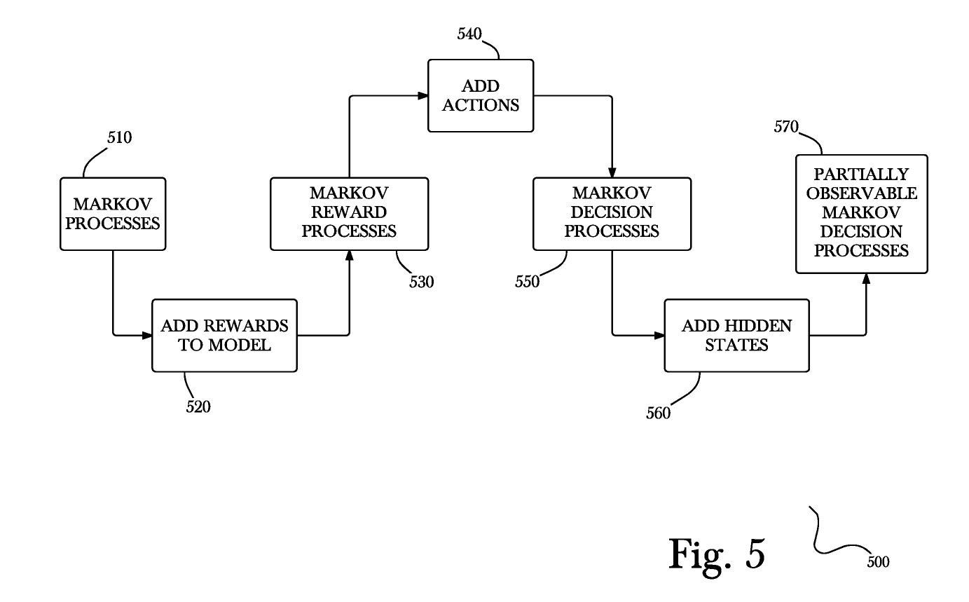

FIG. 5 is a flow diagram illustrating an exemplary method for creating a partially observable Markov decision process 500 for use by reinforcement learning module 300, according to one aspect. First, a Markov process 510 is selected for use, to which rewards are added 520 to become a Markov reward process 530. Decision processes require the concept of a reward in order to quantify which decision results in the better outcome over time. Actions are added 540 to create a Markov decision process 550, such that hidden states may be added 560 to obtain a partially observable Markov decision process (POMDP) 570.

According to one aspect, decisions of optimal actions to be executed to yield a most desirable outcome, even a best outcome, of processes running within a contact center may be expressed through a partially observable Markov decision process (POMPD) 570. The POMDP 570 is defined by a tuple [symbol] [symbol] , [symbol] , [symbol] , P, R, Z, γ [symbol] , where:

[symbol] is a finite set of possible states

[symbol] is a finite set of observations

[symbol] is a finite set of possible actions to be considered

P is a state transition probability matrix

R is a reward function

Z is an observation function

γ is a discount factor between zero and one

Additionally, a matrix P or P_{ss′}^{a} is a conditional probability of a transition from state s at time t to a state s′ at time t+1 given that the state was s at time t and under the effect of action a,

P_{ss′}^{a}= [symbol] [Sₜ₊₁=s′|Sₜ=s, Aₜ=a]

A reward function R or Rₛ^{a} is an expected (mean) value of the reward at time t+1 after starting in state s at time t and under the effect of action a,

Rₛ^{a}= [symbol] [Rₜ₊₁|Sₜ=s, Aₜ=a]

An observation function Z or Z_{s′o}^{a} is a probability of observing observation o at time t+1 given that the system was in state s′ at time t+1 and had experienced action a,

Z_{s′o}^{a}= [symbol] [Oₜ₊₁=o|Sₜ₊₁=s′, Aₜ=a]

Standard reinforcement learning algorithms follow 3 different approaches. Valued Based (estimates the optimal value function), Policy-based (search for the optimal policy directly) and Model-based.

Value-based reinforcement learning may involve estimating “value functions” of state-action pairs to estimate how good it is to perform a specific action in a given state based on accumulated future rewards. The value of a state s under a policy π is the expected return when starting in state s and following policy π.

$${v}_{π} ( s ) {=}^{def} {π}_{} [ {\sum }_{k = 0}^{∞} {γ}^{k} {R}_{t + k + 1} \vert {S}_{t} = s ]$$

An optimal policy π* is one that maximizes υ_{π}(s).

However, reinforcement learning (RL) may use deep neural networks to represent the value function, the policy and the model. The loss function may be optimized by stochastic gradient descent. This leads to value-based deep RL, policy-based deep RL and model-based deep RL variant approaches that may be employed in the solution of the POMDP 570.

FIG. 6 is a process flow diagram illustrating an exemplary method for a reinforcement learning approach 600, according to one aspect. In this aspect, a computational agent 610 may interact with an environment 630 by receiving state 640 and reward 650 information and applying actions 620 to an environment 630. The computational agent 610 may be an automated agent, while a contact center 100 is represented within the environment 630. An iteration 660 is illustrated using a dotted line, indicating an incremental time step in process flow 600. The computational agent 610 and the environment 630 may interact at each of a sequence of discrete time steps 660 (t=0, 1, 2, . . . ). At each time step 660, the computational agent 610 receives a representation of the environment's state 640 Sₜ ∈ [symbol] where [symbol] is the set of possible states and as a result selects an action 620 Aₜ ∈ [symbol] (Sₜ) where [symbol] (Sₜ) is the set of actions available in state 640 Sₜ. One time step 660 later, and partly due to the action 620 taken, the computational agent 610 receives a numerical reward 680 Rₜ₊₁ ∈ [symbol] ⊂ [symbol] and finds the environment in a new state 670 Sₜ₊₁. The new reward 680 Rₜ₊₁ instead of the previous reward 650 Rₜ represents the new reward 680 due to the action 620 Aₜ in order to emphasize that the next reward 680 Rₜ₊₁ and next state 670 Sₜ₊₁ are jointly determined.

At each time step 660 the computational agent 610 implements a mapping 690 from states to probabilities of selecting each possible action 620. This mapping 690 is called the computational agent's policy 695, written πₜ where πₜ(a|s) is the probability that the action 620 at time t, Aₜ=a if Sₜ=s . Reinforcement learning methods specify how the computational agent 610 changes its policy 695 as a result of its experience 665, which is the accumulated result of each completed iteration through each time stamp 660. The computational agent's goal is to maximize the total amount of reward it receives over the long run. The time steps 660 need not refer to fixed intervals of real time but may refer to arbitrary successive stages of decision making and acting. Three signal types may be sent between computational agent 610 and environment 620: choices made by the computational agent 610 (actions 620); basis of which choices are to be made by the computational agent 610 (states 670); and the computational agent's 610 goal (rewards 680). It should be appreciated that states and actions may be low-level communication states or actions, or they may be arbitrarily complex, and various levels and combinations of complexity may be possible according to the aspect. The computational agent 610 and environment 630 boundaries represent the limit of computational agent's 610 absolute control, but not necessarily its knowledge. Reward computation is external to the computational agent 610. In practice, multiple computational agents 610 may be operating concurrently, each with a different boundary. They may be hierarchical in that one computational agent may make high-level decisions which form parts of states faced by a second, lower-level computational agent which implements higher level decisions.

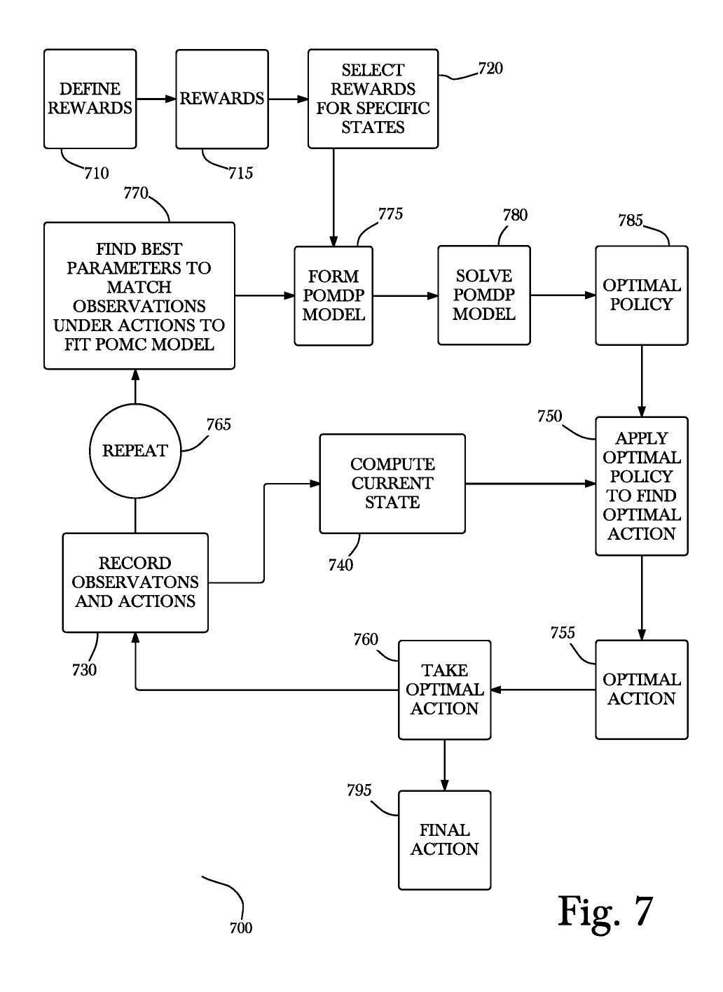

FIG. 7 is a flow diagram illustrating an exemplary method 700 for optimizing states of communications and operations in a contact center by using a reinforcement learning module 300, according to one aspect. With reference to FIG. 4, reinforcement learning may proceed as an iterative process, but once initiated and tested, may be set into motion in real-time, controlled by optimization server 220 which then works with the reinforcement learning server 210 to record more history, develop more training sets, and reapply the model based on more data, learning from more data, and so forth. The reinforcement learning server 210 may receive events and actions during runtime, interpret them, and adjust new actions as operation progresses. The optimization server 220 may carry out instructions from a model 370 using event analyzer 360 to review events and action handler 350 to send action directives based on those events. To initiate a process, rewards must first be defined 710 and, with a set of established rewards 715 for a given goal, rewards are selected for specific states 720. With a series of states and rewards set, a partially observable Markov decision process (POMDP) model is developed 775, in part from an initial partially observable Markov chain (POMC) 770 as well as from a series of selected rewards for specific states 720. Once the POMDP model is formed 775, it can be solved 780 and an optimal policy determined 785. The optimization server 220 is tasked to apply optimal policies to find an optimal action 750, resulting in an optimal action 755 (for the given state 640, reward 650, and time stamp 660) to be identified and executed, in a take optimal action step 760. When the optimal action 760 is taken, it becomes the final action 795 for that time stamp 660, but a history of the optimal action 760 and final action 795 is established to record observations and actions 730, which then feed back into reinforcement learning server 210 to repeat 765 learning and training to find best parameters to match observations under actions to fit an ideal or optimized partially observable Markov chain (POMC) model 770 in order to form a new POMDP model 775 at a new time stamp. Concurrently, resulting from the record of observations and actions 730, the initially formed POMDP model 775 is used to compute a current state 740 at the next time stamp, which then forms input into applying an optimal policy to find an optimal action 750 at the next iterative step. A model manager 380 receives increments from the model 370, from the reinforcement learning server 210 and dynamically updates the model 370 that is being used. Model manager 380 maintains a version of what is the current model 370 (associated with a given time stamp), as well as has an option to change the model by forming a new POMC 770 each time an incremental dataset is received, which may even mean changing the model every few minutes, or even seconds, or after a prescribed quantity of changes are received.

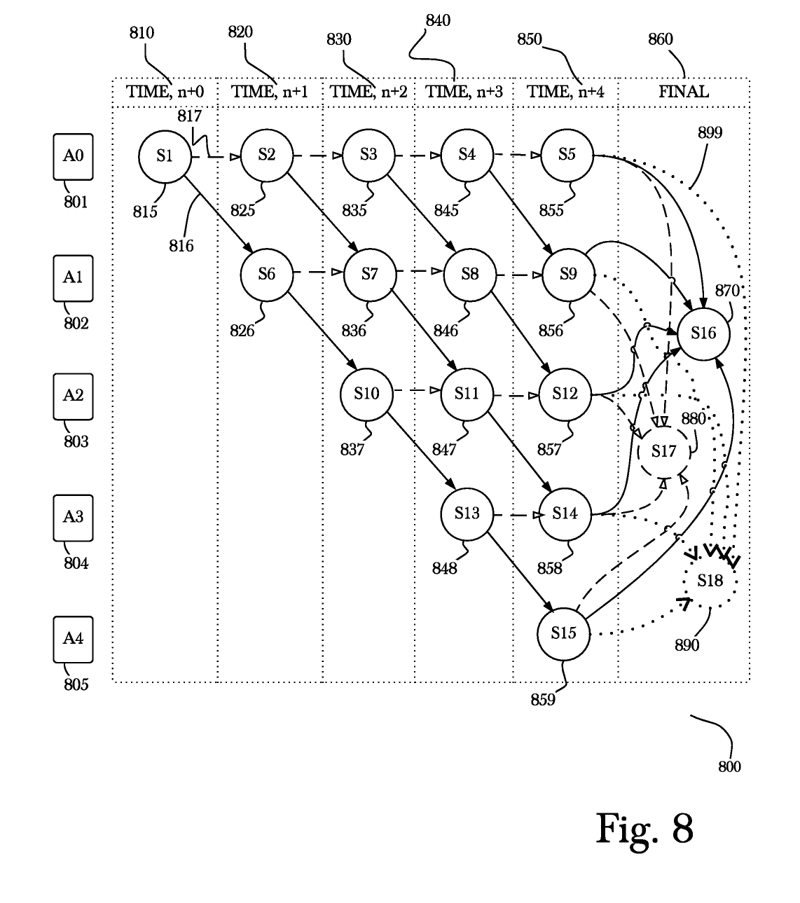

FIG. 8 is a process flow diagram illustrating an exemplary method 800, for optimal interaction planning for outbound sales leads, depicted as a sales funnel with actions based on a fully observable Markov decision process (MDP), according to one aspect. For the sake of clarity, transition lines between each terminal state S16 870, S17 880, and S18 890 and all other states have been omitted. Viewing FIG. 8 from left to right, a first time increment, TIME n+0 810 represents an initial state S1 815 with no action taken, represented as A0 801. To progress to a next time step, a decision is made and the state S1 815 either takes an action 816 or no action 817. It is important to note, that while taking no action is, in principle, an action, an action of taking no action 817 is represented by a dashed line, and an action of taking action 816 is represented by a solid line in FIG. 8. Progressing S1 815 from an initial time, TIME n+0 810 to a next step, TIME n+1 820 has state S1 815 progressing either with no action 817 to become state S2 825, or S1 815 may progress with action 816 into a new state S6 826 associated with an action A1 802. At TIME n+1 820, two states exist: S2 825 and S6 826, as do two actions A0 801 and A1 802. Both states progress in similar fashion, with a decision to progress to a next time stamp TIME n+2 830, resulting in S2 825 either taking no action to become S3 835 or taking action to become S7 836. At the same time, S6 826 moves forward to the next time stamp TIME n+2 830 by either taking no action to become S7 836 or by taking action A2 803 to become S10 837 associated with action A2 803. At time TIME n+2 830 three states exist: S3 835, S7 836 and S10 837, each in a respective action category. All three states progress to time stamp TIME n+3 840 yielding four new states: a no action state S4 845 at action A0 801; a state S8 846 resulting from S3 835 taking an action A1 802 and from S7 836 taking no further action and remaining in action A1 802; a state S11 847 resulting from S7 836 taking an action A2 803 and from S10 837 taking no action; and S13 848 resulting from S10 837 taking an action A3 804. A next time stamp TIME n+4 is illustrated for exemplary purposes and as a next to last time stamp in process flow 800, but it is indicated for brevity, and the aspect should not be taken to be exhaustive after five iterations, as illustrated. But for case of example, in a next time stamp TIME n+4 850, five states exist: S5 855 resulting from no action, A0 801, being taken; S9 856 resulting from S4 845 taking an action A1 802 and from S8 846 taking no further action and remaining in action A1 802; a state S12 857 resulting from S8 846 taking an action A2 803 and from S11 847 taking no action and remaining in action A2 803; a state S14 858 resulting from S11 847 taking an action A3 804 and from S13 848 taking no action and remaining in action A3 804; and S15 859 resulting from S13 848 taking an action A4 805. These five states: S5 855 at action A0 801, S9 856 at A1 802, S12 856 at A2 803, S14 858 at A3 804, and S15 859 at A4 805, may converge on a final 860 outcome at a time step following the previous step TIME n+4 850, by taking an action leading to a good outcome, S16 870; or by not taking an action leading to a bad outcome, S17 880; or by progressing to a state that is out of model, S18 890. Transitions of states to move out of model are indicated by a dotted line 899 and dotted lines 899 lead to the out-of-model state S18 890, and while out-of-model movements may be possible at all previous time stamps, illustration of incremental out-of-model movements has been omitted for clarity, as indicated above.

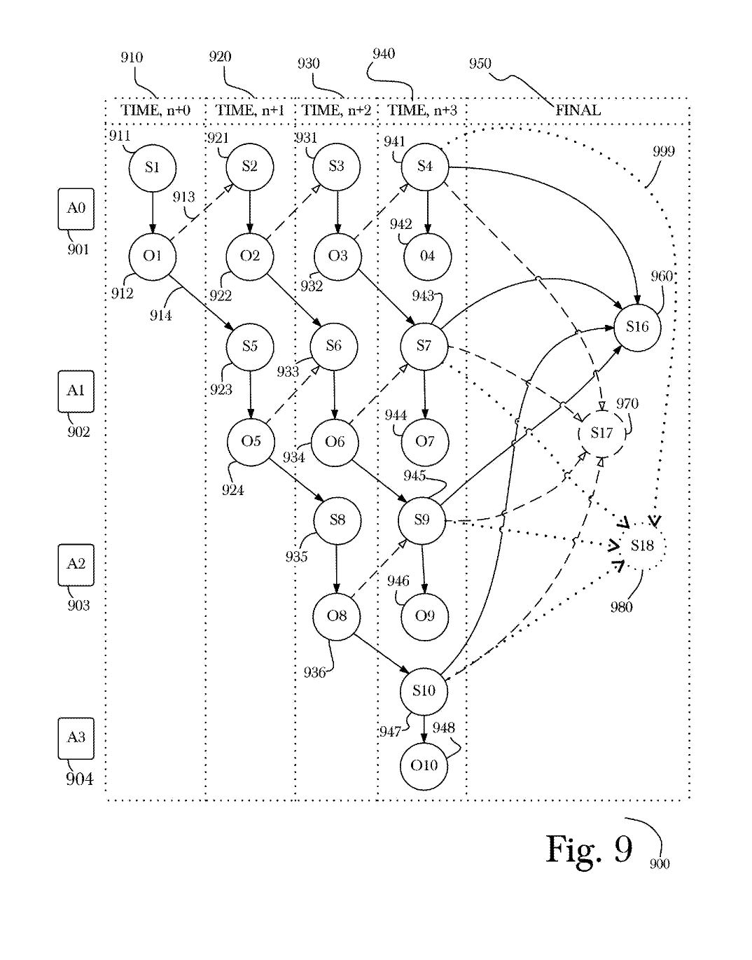

FIG. 9 is a process flow diagram illustrating an exemplary method 900 for optimal interaction planning for outbound sales leads, depicted as a sales funnel with actions as a partially observable Markov decision process, according to one aspect. For the sake of clarity, transition lines between each terminal state S16 960, S17 970, and S18 980 and all other states have been omitted. Viewing FIG. 9 from left to right, a first time increment, TIME n+0 910 represents an initial state S1 911 and a corresponding observation O1 912, with no action taken, represented as A0 901. To progress to a next time step, a decision is made and the state S1 911 relating to the observation 912 either takes an action 914 or no action 913. It is important to note, that while taking no action is, in principle, an action, an action of taking no action 913 is represented by a dashed line, and an action of taking action 914 is represented by a solid line in FIG. 9. Progressing O1 912 from an initial time, TIME n+0 910 to a next step, TIME n+1 920 has an observation O1 912 progressing either with no action 913 to become state S2 921 with a corresponding observation O2 922, or O1 912 may progress with action 914 into a new state S5 923 associated with an action A1 902 and S5 923 transitions to O5 924 within action A1 902. At TIME n+1 920, two states with their matching observations exist: S2 921/O2 922 and S5 923/O5 924, as do two actions A0 901 and A1 902. Both states and corresponding observations advance in similar fashion, with a decision to advance to a next time stamp TIME n+2 930, resulting in O2 922 either taking no action to become S3 931 and O3 932 or taking action to become S6 933 and O6 934. At the same time stamp TIME n+1 920, O5 924 moves forward to the next time stamp TIME n+2 930 by either taking no action to become S6 933 which produces observation O6 934 and staying within action A1 902, or by taking action A2 903 to become S8 35 and corresponding observation O8 936 associated with action A2 903. At time TIME n+2 930 three states and their corresponding observations exist: S3 931/O3 932 , S67 933/O6 934, and S8 935/O8 936 , each pair in a respective action category, A0 901/A1, 902/A2, 903. All three states and corresponding observations advance to time stamp TIME n+3 940 yielding four new states and corresponding observations: a no action state S4 941 and corresponding observation O4 942 at action A0 901; a state S7 943 and corresponding observation O7 944, resulting from O3 932 taking an action A1 902 and from O6 934 taking no further action and remaining in action A1 902; a state S9 945 and corresponding observation O9 946, resulting from O6 934 taking an action A2 903 and from O8 936 taking no action; and state S10 947 with corresponding observation O10 948, resulting from O8 936 taking an action A3 904. These four state and observation pairs: S4 941/O4 942 at action A0 901, S7 943/O7 944 at A1 902, S9 945/O9 946 at A2 903, and S10 947/O10 948 at A3 904, may converge on a final 950 outcome at a time step following the previous step TIME n+3 940, by taking an action leading to a good outcome, S16 960; or by not taking an action leading to a bad outcome, S17 970; or by progressing to a state that is out of model, S18 980. Transitions of states to move out of model are indicated by a dotted line 999 and dotted lines 999 lead to the out-of-model state S18 980, and while out-of-model movements may be possible at all previous time stamps, illustration of incremental out-of-model movements has been omitted for clarity, as indicated above.

SLIO 200 may be configured to inherently accommodate uncertainty in terms of transition probabilities between states and probabilistic observation functions, and may perform optimal decision making under uncertainty. This configuration of SLIO 200 makes it possible to statistically infer hidden states even though they are not directly observable, as well as makes it possible to represent actions associated with the SLIO 200 and its communications platforms. In one aspect, the SLIO 200 finds an action policy that has a maximum value of expectation (mean) value of net accumulated reward (total return) over a time horizon in presence of uncertainty of different scenarios. Global constraints on actions are represented by an absence of impermissible actions in formulation of the model 370 and constraints on entering disallowed or undesirable states are represented by large penalties or negative action rewards for actions that have a nonzero probability of transition to disallowed states. Use of SLIO 200 clearly enables optimal actions to be computed for any given state of SLIO 200 and for those actions to be executed.

Other applications may be possible such as (for example, including but not limited to) routing of a plurality of outbound interactions to distribute in a preferred arrangement to available agents or other resources, outbound dialing and pacing, workforce management and staffing planning, or resource allocation. For example, optimal interaction planning for outbound sales leads (when and how often and by what channel should an outbound lead be contacted), optimal skills based routing for inbound interactions (with certain parameters known, such as current system state, number of interactions in queue, number of agents available, paired with more positive rewards based on matching of a skill request with an agent skill, find most optimal actions of routing to an agent in each time step), optimal intraday staffing (actions are which agents to schedule at what time and for how long, as well as servicing of interactions by a well-matched agent), learning optimal channel and times for communication to a customer device, simplification of state handling in developer applications by updating state process and deaccessioning model to cloud as data, not as code, optimal cloud resource management, cloud platform optimizes its response to API actions to maximize reward, etc. In a general sense, an entire customer or agent “journey” could be modeled as a Markov decision process, subject to actions along the way.

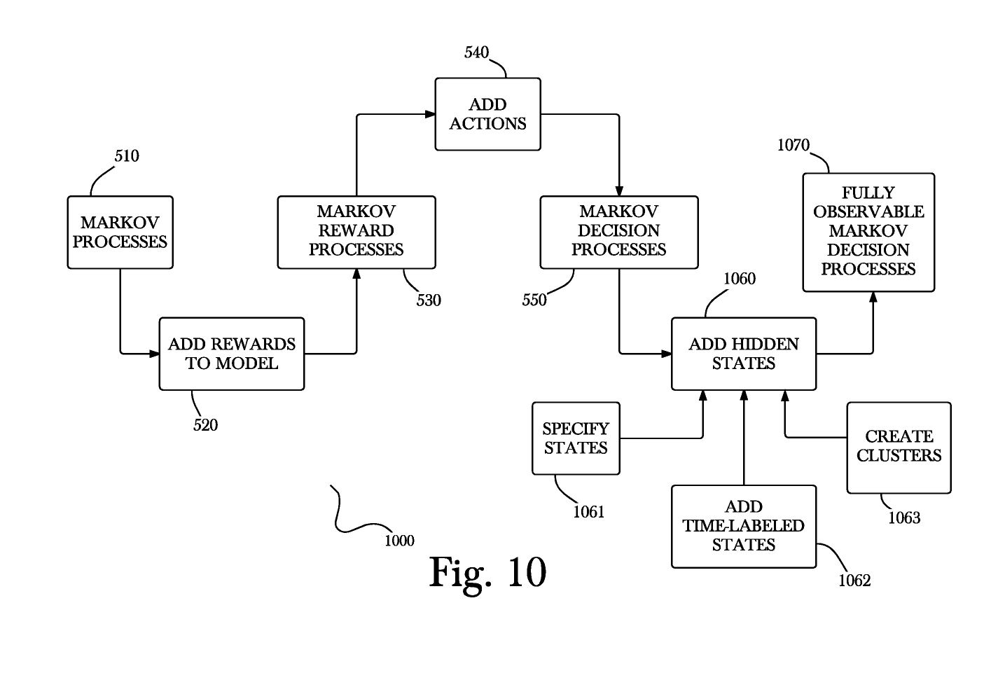

A system using a Markov decision process may be built and configured for a contact center to include simultaneous states of interactions and agents. A fully observable Markov decision process may be implemented by creating a Markov chain with actions and rewards, allowing for a system to operate from a hyper-policy that specifies general actions to take such that rewards are maximized over a specified time or horizon. Actions need not be limited to typical routing actions, such as, for example, communication interactions and agent selection, but may be generalized to include actions related to scale-up or scale-down of resources 120 or scaling of other resources, such as, for example, cloud computing resources. Time may be discretely introduced to a Markov chain by introducing time-labeled states, which may be used to model waiting or service times. Therefore, by modifying the exemplary method for creating a partially observable Markov decision process 500 for use by reinforcement learning module 300, as illustrated in FIG. 10 below, an exemplary method for creating a fully observable Markov decision process 1000 for use by reinforcement learning module 300 may be implemented to optimize communication operations to include simultaneous specification of all states of interactions, including, but not limited to, interactions involving communications waiting in a queue, communications being served by agents; and may also be implemented to include simultaneous specification of all states of agents, including, but not limited to, idle, ready, and active or engaged; and may be implemented to include simultaneous specification of all states of agent resources and interactions.

FIG. 10 is a flow diagram illustrating an exemplary method for creating a fully observable Markov decision process 1000 for use by reinforcement learning module 300, according to one aspect. Similar to the process illustrated in FIG. 5, a Markov process 510 is selected for use, to which rewards are added 520 to become a Markov reward process 530. Decision processes require a concept of reward in order to quantify which decision results in an optimal outcome over a horizon, typically equating to time. Actions are added 540 to create a Markov decision process 550, such that a known, finite number of hidden states may be added 1060 to obtain a fully observable Markov decision process 1070. Within the step of adding hidden states 1060, the hidden states may be specified 1061, may be labeled with time 1062, and may be separated into clusters 1063 such that a number of states in the fully observable Markov decision process 1000 are known and limited, where clusters may contain segments of interactions or agent resources, and the hidden states 1060 interact with clusters and not individual agent resources or interaction channels. Segmentation of interactions into clusters may be accomplished using prior knowledge and application rules applied, such as, for example: skill sets requested by a business type, e.g., product X sales, product Y service, or text channel 140 type or multimedia channel 145 type; or value segment of a customer 110 based on status or designation of preferred service level, such as platinum, gold, silver, etc., based on an expected return. Further, segmentation of interactions into clusters may be accomplished by implementing a supervised machine learning model to predict and classify an interaction state from available input data, and where no data is available, a suitable set of cluster labels may be used as segments, and applied to compute a clustering algorithm to historical data such that initial input data needed for an iterative process may be synthesized. Segmentation of agent resources may be accomplished by using prior knowledge of skills possessed by each agent resource 120, which may include hourly rate or implicit skill set in a business type, or may be accomplished by implementing a supervised machine learning model to predict and classify an agent resource 120 state from available input data, and where no data is available, a suitable set of cluster labels may be used as segments, and applied to compute a clustering algorithm to historical data such that initial input data needed for an iterative process may be synthesized.

According to one aspect, decisions of optimal actions to be implemented and executed to yield a most desirable outcome, even a best outcome, of communication operations running within a contact center may be expressed through a fully observable Markov decision process (MPD) 1070. In a similar fashion to the derivation of POMDP 570, the MDP 1070 is defined by a tuple [symbol] [symbol] [symbol] P, R, γ [symbol] , where:

[symbol] is a finite set of possible states

[symbol] is a finite set of possible actions to be considered

P is a state transition probability matrix (a separate matrix for each action)

R is a reward function

γ is a discount factor between zero and one

An overall state of the reinforcement learning system 200 may be represented as S. and may be decomposed into a finite number of possible states, (of interactions) N_{Q}, in a queue: Q0, Q1, . . . Q[N_{Q}−1]; and into a finite number of possible states, (of interactions being addressed by agent resources) N_{A}, agent resource state: A0, A1, . . . A[N_{A}−1], where a special state Q0 corresponds to an empty queue and where a special state A0 corresponds to all agent resources idle. Transition probabilities may change over time due to any number of uncontrolled actions, such as customer 110 disconnecting due to impatience, or agent resource 120 delayed reporting of availability. The Markov decision process model 1070 may be created as a non-stationary policy, or hyper-policy, by expanding a state definition to include an explicit time stage label, t0, t1, . . . , tN, and considering a state subspace Q to be enlarged by including time units spent waiting in queue and a state subspace A to include a number of time units spent being engaged or active. The finite number of possible states, [symbol] , of the queue, No, may be determined considering all possible interactions types (skill request expressions) and number of interactions of each type waiting in each queue for a range of time units up to a maximum model queue time (horizon), such that an order of interactions in a queue is not important, only wait time counts are captured. Alternatively, queue states may be distinguished by order. All possible combinations of queue interactions and agent resource states may be specified in the overall state space of the SLIO 200, where S={Q0A0, Q1A0, Q1A1, Q2A0, Q2A1, Q2A2, . . . , QnAn}. Similarly, the Markov decision process model 1070 may be further extended to a partially observable model, for example, when relating a known state of a customer 110.

A non-stationary policy, otherwise termed herein as a hyper-policy, specifically as referenced above, may be implemented to identify optimal actions to take at state, S, with a known number of ‘t’ stages within a specified horizon, H. This may be represented as π(s, t), where π:S×T −>A, and T comprises a set of non-negative integers. A finite planning horizon, H, comprising a finite number of stages, ‘t’, may be established such that a finite count of actions may be determined. Actions may involve routing of interactions to agent resources or changing a quantity of available or potentially-engaged agent resources according to changing needs of the reinforced learning system 200. Given a Markov decision process 1070 and a known horizon, H, for example, one day, an optimal finite-horizon policy may be computed using, for example, a backward induction algorithm that starts from the end of the known horizon, e.g. one day, and working backwards to find optimal actions to take at each stage or time point, t, manipulated to determine an optimal value function for a know horizon, H. Backwards induction algorithms require some level of initial approximation in order to compute and optimized policy, and may follow: myopic policies, which optimize current cost but do not apply forecasts or representations of future decisions; look-ahead policies, which explicitly optimize over a future horizon with approximated future data and actions applied; policy function approximations, which directly return an action in a given state with no embedded optimization or forecast of future data applied; and value function approximations (greedy policies) using an approximation of value being in a future state as a result of a decision currently made, with any impact of future actions solely in this value function.

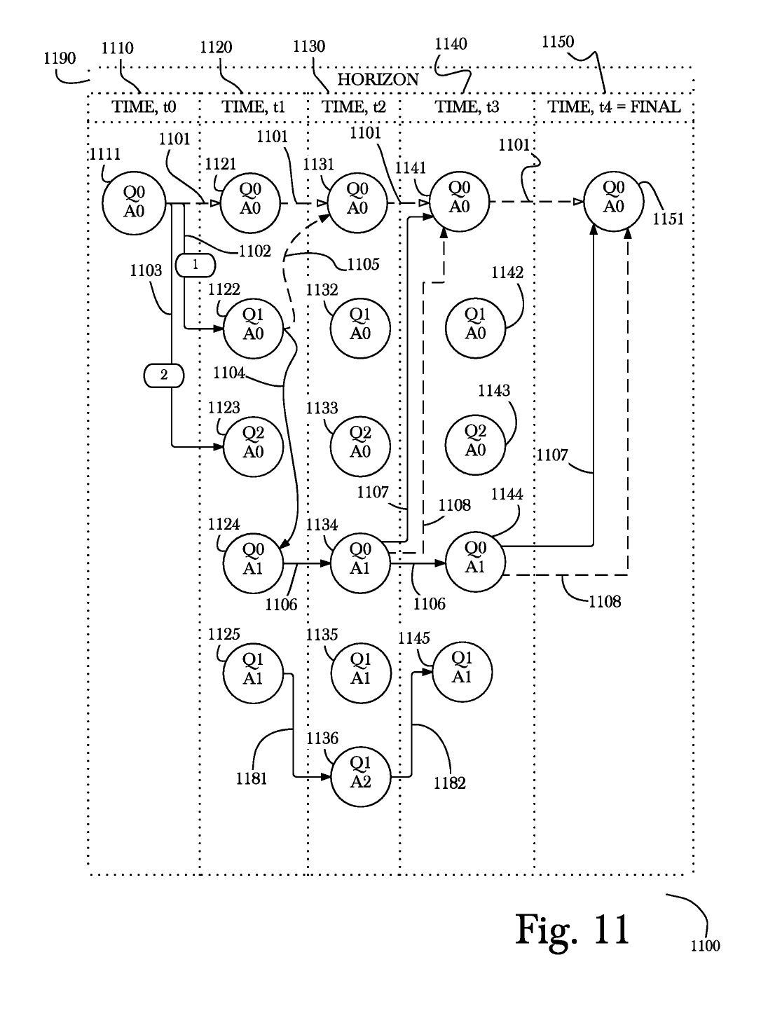

FIG. 11 is an exemplary state transition diagram 1100 using a non-stationary hyper-policy over a given horizon 1190 for optimal interaction planning and for routing communications and staffing agent resources, using a fully observable Markov decision process 1070, according to one aspect. A simplified view of state transitions, actions, and rewards is illustrated. In state transition diagram 1100, a horizon 1190 of one day is separated into five time slots: TIME, t0, 1110, representing the beginning of the horizon 1190; TIME, t1, 1120, representing a next stage of horizon 1190; TIME, t2, 1130, representing a next stage of horizon 1190; TIME, t3, 1140, representing a next stage of horizon 1190; and TIME, t4=FINAL, 1150, representing a final or last stage of horizon 1190. In the exemplary state transition diagram 1100, a start of day one 1110 is in a state t0Q0A0 1111 with no calls in queue, represented by a dashed line and empty arrow 1101, and no agent resources engaged, A0. There is a non-zero probability of one call 1102 arriving at stage t1 1120, where the state transitions to t1Q1A0 1122 (one call in queue and no agent resources engaged). A routing action 1104 is taken resulting in a state t1Q0A1 1124 with no calls in queue and one agent resource engaged. At state t1Q1A0 1122, should the call in queue be dropped or abandoned, an empty call path 1105 transitions to a new stage state t2Q0A0 1131. Another possibility to arrive at t2Q0A0 1131 may come from a previous stage at t1 1120, whereby no call arrives from t1Q0A0 1121 via a no call in queue 1101. Following this logic, and continuing from t1Q0A1 1124, a call may be in progress 1106 leading to t2Q0A1 1134, with no call in queue and one agent resource engaged at time t2 1130. At a next stage, t3 1140, a call may remain in progress 1106 yielding a t3Q0A1 1144 state or the call may terminate by either a sale being made 1107 or no sale being made 1108, transitioning to state t3Q0A0 1141. Assuming the agent resource remained engaged on the call through state t3Q0A1 1144, an outcome is finally concluded at the end of day in stage t4FINAL 1150, with a sale being made 1107 (positive outcome) or a sale being lost 1108 (negative outcome) returning the state to t4Q0A0 1151. In another case, at state t1Q2A0 1123, two calls 1103 are in queue with zero agent resources engaged, A0. With no agent resources allocated, state t1Q2A0 1123 transitions to t2Q2A0 1133 at the next time stage t2 1130 and on to t3Q2A0 1143. Similarly, t3Q1A0 1142 results from t2Q1A0 1132 which results from t1Q1A0 1122 assuming neither routing action 1105/1106 occur. Within the same case 1100, assuming horizon 1190, other actions may be executed, such as, for example, engaging a second agent resource by transferring a call at t1 1120 in state t1Q1A1 1125 to state t2Q1A2 1136 by routing and engaging a second agent resource 1181. It may be that a second agent resource is needed for a specific skill set or to engage at a specific performance level, or to relieve a first agent resource to free up for a next-queued call. A second agent may be disengaged by rerouting to the first agent 1182 to state t3Q1A1 1145. Assuming no action is taken from state t1Q1A1 1125, the state progresses to t2Q1A1 1135 and possibly on to t3Q1A1 1145 yielding no results and no action. Other actions may be performed, such as engaging new agent resources, assigning new engagements to agent resources, or disengaging agent resources. Many logical constraints are possible, and not all possible connections between states are identified within FIG. 11, but examples given follow a left-to-right time dependency, which itself may be altered to suit specific system logic, and should not be understood as limiting in any way.

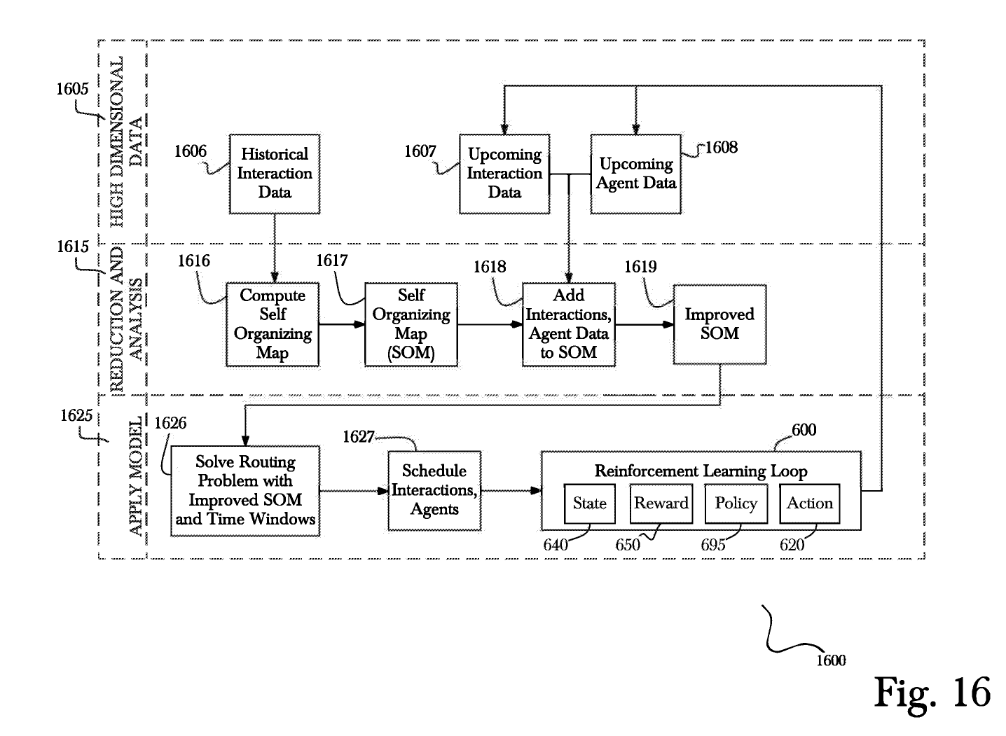

FIG. 16 is an exemplary state transition diagram 1600 illustrating a plurality of events that may occur in one or more possible stages during management of state explosion within reinforcement learning applications associated with optimized workforce management according to one aspect. With reference to FIG. 6, multiple computational agents 610 may be operating concurrently, each with a different boundary. They may be hierarchical in that one computational agent may make high-level decisions which form parts of states faced by a second, lower-level computational agent which implements higher level decisions. With respect to states and management of states within reinforcement learning, state explosion may occur when high dimensional data 1605, which may be associated with attributes of interactions or skills of agents, for example, is incorporated into a reinforcement learning process. State diagram 1600 illustrates a semi-iterative solution which may run by a computational agent 610 to categorize, reduce and manage high dimensional data 1605 such that it may be processed and streamlined by a reinforcement learning system 300. High dimensional data 1605 may enter as historical interaction data 1606, or upcoming interaction data 1607 or upcoming agent data 1608. Considering a routing problem with high dimensional data 1605 as historical interaction data 1606, an action taken to reduce and analyze 1615 the historical interaction data 1606 may compute a self-organizing map (SOM) 1616 and yield a self-organizing map (SOM) 1617 to which upcoming interaction or agent data may be added 1618 to generate an improved SOM 1619 which may be used to solve a routing problem 1626 by applying a model 1625 to the improved self-organizing map 1619, which may include horizons of time, in order to schedule interactions or agents 1627 as input to reinforcement learning approach 600 which may process as an iterative loop, and which may include state 640, reward 650, policy 695, and action 620, to determine upcoming interaction data 1607 or upcoming agent data 1608 which may be classified as high dimensional data 1605 but is not required to be maintained as such, and for simplicity of the state interaction diagram 1600, are illustrated as high dimensional data 1605 even though said data sets 1607/1608 may be sourced and inserted should dimensions of data classify them as not being high dimensional.

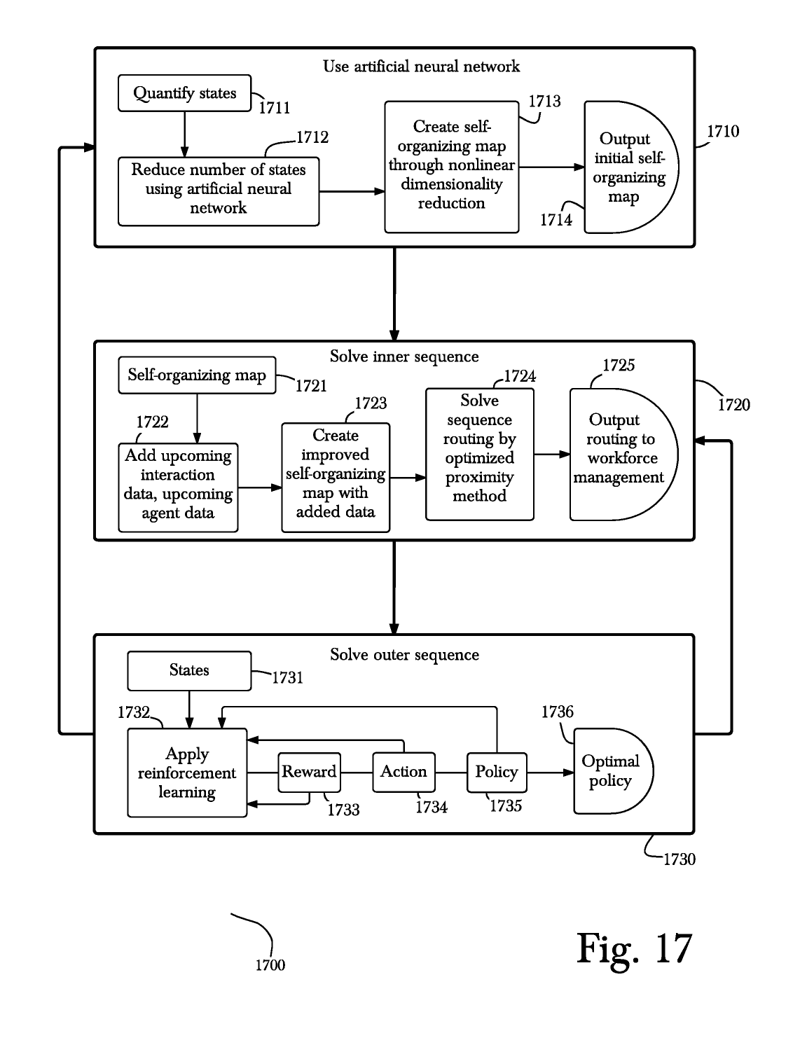

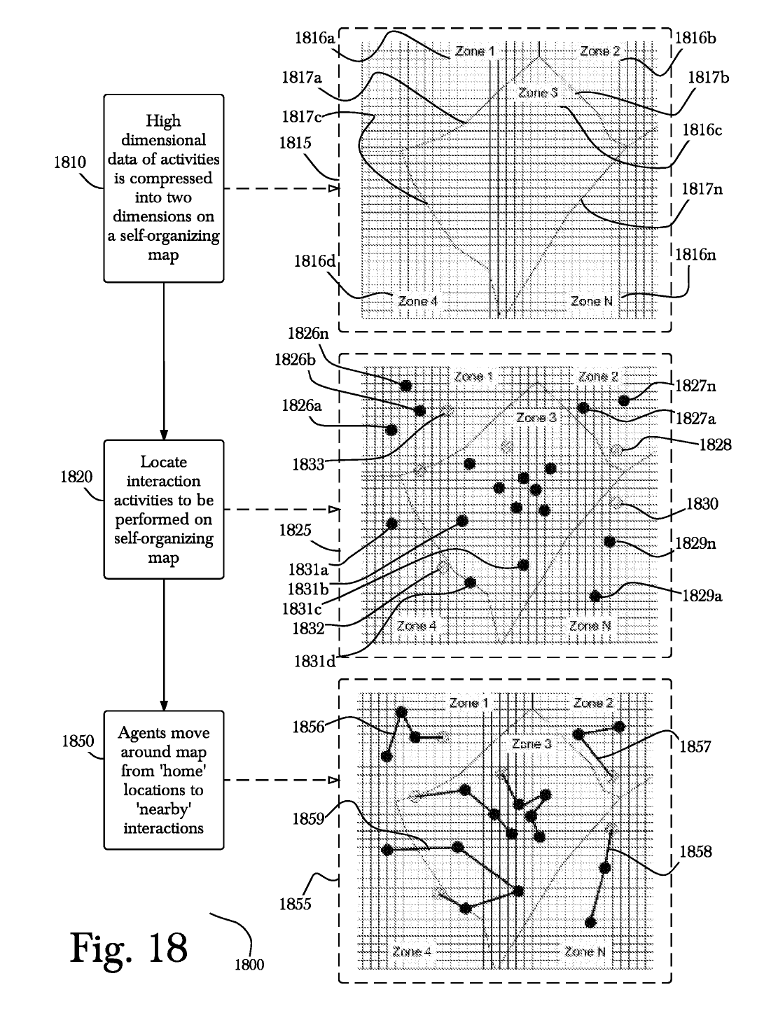

FIG. 17 is a flow diagram depicting an exemplary method 1700 for reducing and managing state explosion that may occur when processing high dimensional data through reinforcement learning, according to one aspect. In a first step 1710, an artificial neural network is employed to: quantify states 1711, reduce the number of states using an artificial neural network 1712 to create a self-organizing map through nonlinear dimensionality reduction 1713 to output a self-organizing map 1714 to be used in a next step to solve an inner sequence 1720. This may use the output from the first step 1710 to start with a self-organizing map 1721 to which upcoming interaction or agent data may be added 1722 to create an improved self-organizing map with added data 1723 to solve the sequence routing problem by optimized proximity method 1724 to determine output routing for workforce management 1725. An exemplary optimized proximity method 1800 is further discussed in FIG. 18. Following solution to the inner sequence 1720, a final step to solve an outer sequence 1730 proceeds with states 1731 as input to apply reinforcement learning 1732 to determine an optimum policy 1736 through iterative developments of reward 1733, action 1734, and policy 1735, each of which may progress to a next sub-step, for example reward 1733 may progress to action 1734 and on to policy 1735 or reward 1733 may return to apply reinforcement learning to develop a more optimal reward 1733 and so on. Ultimately, an optimal policy 1735 is derived and may be applied within reinforcement learning approach 300 to determine an optimal routing process to follow for a given set of inputs and parameters, as described previously.

FIG. 18 is another flow diagram depicting an exemplary optimized proximity method 1800 for reducing and managing state explosion that may occur with high dimensional data, according to one aspect. In a first step, high dimensional data of activities may be compressed into two dimensions on a self-organizing map 1810, such as a grid-zoned self-organizing map 1815 comprising a plurality of zones 1816a-n and where hard-lined differentiation 1817a-n between zones may occur but may also blend with no hard-lined definition. In a next step, interaction activities to be performed are located 1820 on the grid-zoned self-organizing map 1815 to create an interaction activity grid-zoned self-organizing map 1825 with interaction activities represented by solid-filled circles clustered in zones 1816a-n, such as interaction activities 1826a-n in zone 1 1816a, or interaction activities 1827a-n in zone 2 1816b, and so on up to interaction activities 1829a-n in zone N 1816n. Agents, represented by hashed-filled circles 1828, 1830, 1832, 1833 in zones 1816a-n, similarly, are located on grid-zoned self-organizing map 1825 according to a plurality of parameters associated with their state(s), which may include knowledge specialty as well as availability, proficiency, and such, to address interaction activities which are close by, or within close proximity of their respective location on grid-zoned self-organizing map 1825. For example, in zone 1 1816a, agent 1833 may be initially assigned to address interaction activities 1826a-n due to agent's location or proximity to interaction activities 1826a-n. However, routing and order of interaction activities address may be assigned or reassigned by optimization server 220 in conjunction with reinforcement learning server 210, based on outcomes of interactions made in time, which may alter states such that revised routing is applied. In another example, agent 1828 is located in zone 2 1816b, along with interaction activities 1827a-n. However, in another example, agent 1832 is located in zone 4 1816d where only one interaction activity 1831a has been mapped. Another interaction activity 1831d has been mapped on definition line 1817c separating zone 3 1816c from zone 4 1816d. Interaction activities 1831b-c are identified for purposes of example, and have been mapped in zone 3 1816c. Other interaction activities are illustrated as having been mapped in zone 3 1816c but are not discussed for ease of illustration. Still, interaction activities and agents may be located or mapped anywhere on grid-zoned self-organizing map 1825 and actions taken are assigned in a final step, 1850 where agents move around map from ‘home’ or initial location to ‘nearby’ or proximal locations, regardless of zone allocation. Routing of agents to interactions may be represented with an optimized grid-zoned self-organizing map 1855, where routing paths 1856, 1857, 1858, 1859 are routed from agents to interaction activities in order by connecting dots with lines or curves, as the case may be, from, for example, from agent 1828 to interaction activity 1827a by route path 1857, and in this case, with route path 1857 continuing to interaction activity 1827n in zone 2 1816b. In another example, agent 1832 located in zone 4 1816d may be routed along path 1859 to address interaction activities 1831d, which shown to be mapped on definition line 1817c between zone 4 1816d and zone 3 1816c. Just because the agent 1832 is located in zone 4 1816d does not mean that all interaction activities to be addressed by agent 1832 are limited to those only located in zone 4 1816d. There may be a plurality of other factors being considered by reinforcement learning module 300 to route agent 1832 along path 1859, so it is important to note the identification of zones may be interpreted as being loosely organized such that agents may cross from zone to zone, which may be based on various skill sets, availability or the like.

FIG. 19 is a set 1900 of diagrams 1910, 1920 presented to illustrate context-switching costs and the selection of an agent routing solution, according to one aspect. In a first diagram 1910, a plurality of nodes 1912a-n may represent a plurality of interaction activities, and an agent 1911 may be assigned a routing path 1913 to define said agent's 1911 course of activities to address, and in what order. The apparent path represents a two-dimensional visualization of similarity measures between tasks, wherein movement along either axis in the visualization indicates similarity between work items and reveals a “context switching cost” incurred when switching between work items, referring to an inherent loss of productivity experienced when attention is diverted to a new topic or interrupted. Tasks that are related may have a lower switching cost due to familiarity and may form a natural work flow for an agent, while switching between different tasks or task types may have a greater impact as the agent must adjust to the new information and tasks needed.

A second diagram 1920 is shown to represent the same plurality of nodes 1912a-n but where a time-window or horizon may be applied that may alter the route or path 1914 and paths may intersect 1915 as shown between node 1912c and 1912d. Path routes may run in any direction according to the context-switching cost as directed by the reinforcement learning module 300 and crossing of paths need not be avoided, or may represent other factors, related to utilization ratios or efficiencies pertaining to an agent's 1911 work or ability to execute the altered path 1914 given new parameters relating to horizons of time.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

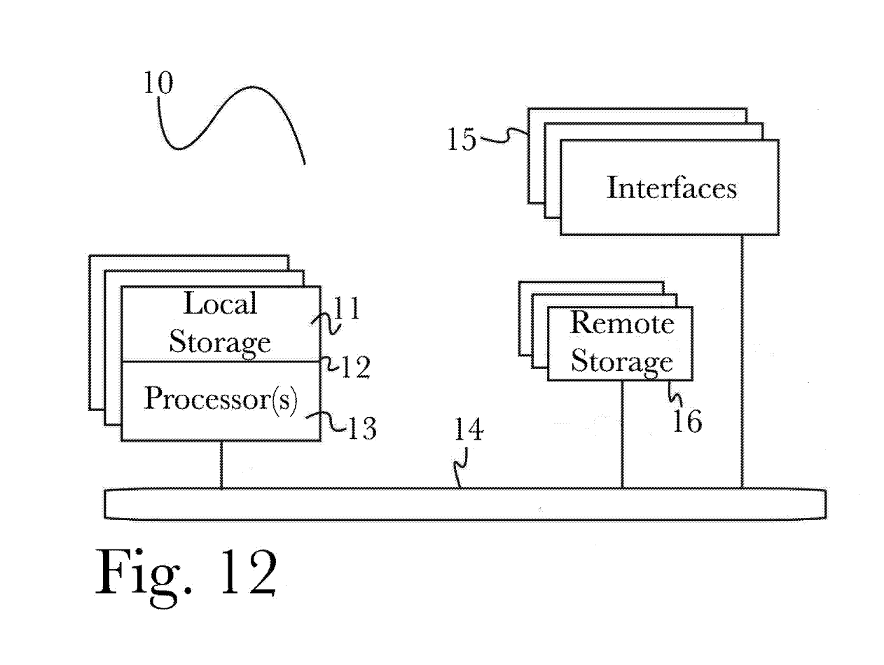

Referring now to FIG. 12, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 12 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

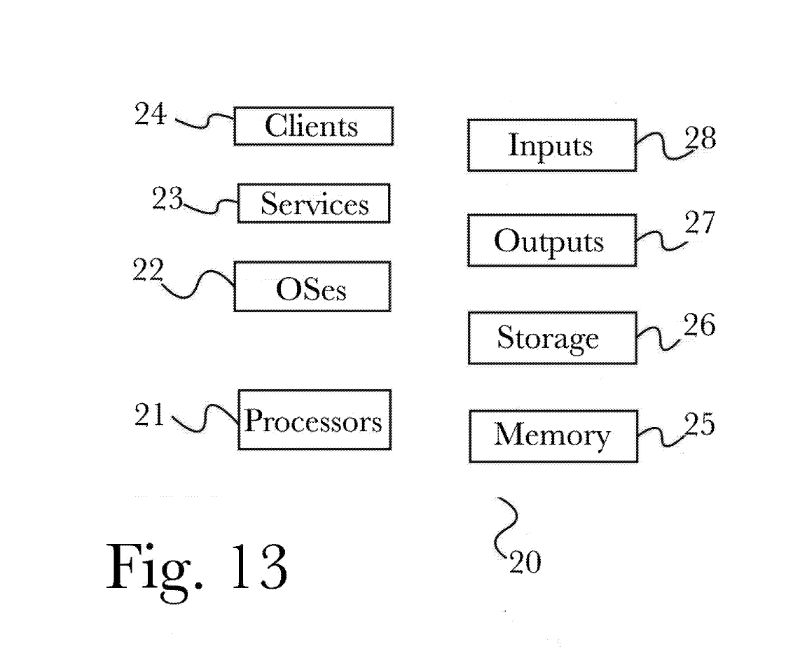

In some aspects, systems may be implemented on a standalone computing system. Referring now to FIG. 13, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 12). Examples of storage devices 26 include flash memory, magnetic hard drive, CD-ROM, and/or the like.

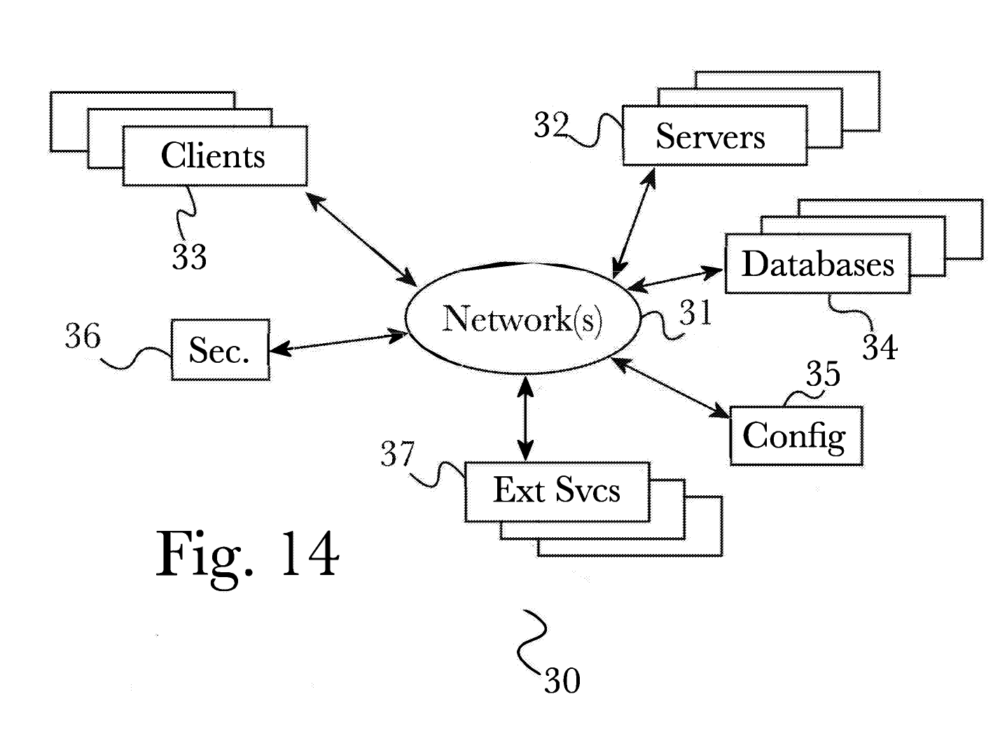

In some aspects, systems may be implemented on a distributed computing network, such as one having any number of clients and/or servers. Referring now to FIG. 14, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 13. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, APACH SPARK™ 0 and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

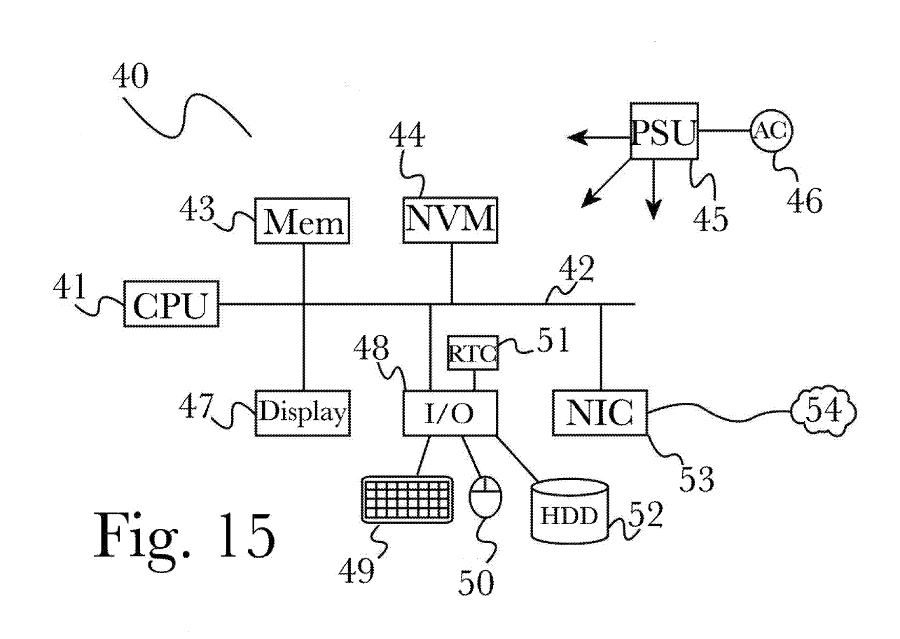

FIG. 15 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for enhanced human/machine workforce management using reinforcement learning comprising:
a reinforcement learning server comprising at least a plurality of programming instructions stored in a memory and operating on a processor of a computing device and configured to:
receive a plurality of historical data from a contact center;
form a partially-observable Markov chain model based at least in part on at least a portion of the historical data;
provide the partially-observable Markov chain model to an optimization server;
an optimization server comprising at least a plurality of programming instructions stored in a memory and operating on a processor of a computing device and configured to:
receive a partially-observable Markov chain model from a reinforcement learning server;
select a plurality of work tasks based at least in part on the partially-observable Markov chain model;
select a plurality of contact center resources;
assign each of the selected work tasks to at least one of the plurality of contact center resources;
record and analyze a plurality of observations based on each selected resource's performance of each work task assigned to it;
provide the observations to the reinforcement learning server;
a retrain and design server comprising at least a plurality of programming instructions stored in a memory and operating on a processor of a computing device and configured to:
observe and analyze a plurality of historical data from a contact center;
provide at least a portion of the historical data to a reinforcement learning server;
define a plurality of reward values to direct the operation of the reinforcement learning server; and
design and train a Markov decision process model based at least in part on the partially- observable Markov chain model, using at least a portion of the defined reward values.

2. The system of claim 1, wherein the plurality of reward values further comprises a plurality of negative rewards, wherein a negative reward is defined as a negative value and the retrain and design server trains away from the reward using negative-reinforcement learning.

3. The system of claim 1, wherein the plurality of contact center resources comprises at least a workforce management system.

4. The system of claim 1, wherein the plurality of contact center resources comprises a plurality of virtual bot workers.

5. A method for enhanced human/machine workforce management using reinforcement learning, comprising the steps of:
receiving, at a retrain and design server comprising at least a plurality of programming instructions stored in a memory and operating on a processor of a computing device, a plurality of historical data from a contact center;
defining a plurality of reward values to direct the operation of a reinforcement learning server;
providing at least a portion of the historical data to a reinforcement learning server for use in a partially-observable Markov chain model;
forming, using a reinforcement learning server, a partially-observable Markov chain model based at least in part on the historical data;
selecting, using an optimization server, a plurality of work tasks based at least in part on the partially-observable Markov chain model;
selecting a plurality of contact center resources;
assigning each of the selected work tasks to at least one of the plurality of contact center resources;
training a Markov decision process model based at least in part on the partially-observable Markov chain model, using at least a portion of the defined reward values.

6. The method of claim 5, wherein the plurality of reward values further comprises a plurality of negative rewards, wherein a negative reward is defined as a negative value and the retrain and design server trains away from the reward using negative-reinforcement learning.

7. The method of claim 5, wherein the plurality of contact center resources comprises at least a workforce management system.

8. The method of claim 5, wherein the plurality of contact center resources comprises a plurality of virtual bot workers.
